(19) United States
(12) Patent Application Publication
(10) Pub. No.: US 2025/0389915 A1
(43) Pub. Date: Dec. 25, 2025

(54) OPTICAL ENGINE MODULE WITH FIBER ARRAY UNIT AND METHODS FOR FORMING THE SAME

(71) Applicant: Taiwan Semiconductor Manufacturing Company Limited, Hsinchu (TW)

(72) Inventors: Wen-Chih Lin, Taoyuan City (TW); Cheng-Yu Kuo, Kaohsiung City (TW); Yen-Hung Chen, Hsinchu City (TW); Hsuan-Ting Kuo, Taichung City (TW); Chia-Shen Cheng, Hsinchu (TW); Pei-Shan Ho, Hsinchu City (TW); Ching-Hua Hsieh, Hsinchu (TW); Wen-Chih Chiou, Zhunan Township (TW); Ming-Fa Chen, Taichung City (TW); Shang-Yun Hou, Jubei City (TW)

(21) Appl. No.: 18/749,947

(22) Filed: Jun. 21, 2024

(51) Int. Cl. G02B 6/42

(52) U.S. Cl. CPC G02B 6/4292; G02B 6/4214

(57) ABSTRACT

An optical engine module may include a backplate, a fiber array unit attached to the backplate, an optical engine die attached to the backplate adjacent the fiber array unit; and a socket attached to the backplate and connected to the optical engine die. A method of forming an optical engine module may include attaching a fiber array unit to a backplate, attaching an optical engine die to the backplate adjacent the fiber array unit, and attaching the backplate to a socket such that the fiber array unit and the optical engine die are between the backplate and the socket.

### BACKGROUND

A Fiber Array Unit (FAU) is an optical component used in optical systems and devices. The FAU may manipulate and/or direct optical signals carried by one or more optical fibers.

The FAU may include a port for a multi-fiber push-on/pull-off (MPO), or one or more optical fiber ports that may serve as an input/output (I/O) interface for optical signals. The optical fiber ports may be arranged in a linear or two-dimensional array. The FAU may also include a fiber holder (fiber receptacle) for each of the optical fiber ports. The fiber holder (fiber receptacle) may securely hold the optical fibers in place to maintain precise alignment and minimize signal loss.

An optical engine (OE) is a component that manages and manipulates light signals within fiber optic systems. The OE may include a combination of optical elements such as lenses, mirrors, and prisms, arranged to efficiently couple light between various optical fibers and other optical components. The role of the OE may include aligning and focusing the light beams to maximize the efficiency of the light transfer in order to minimize loss and ensure optimal performance of the fiber optic network. The OE may be used in various configurations depending on the specific requirements of the system, including single or multi-fiber arrangements.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A is a vertical cross-sectional view of the optical engine (OE) module according to one or more embodiments.

FIG. 1B is a perspective view of the OE module according to one or more embodiments.

FIG. 1C is a perspective view of an OE die and socket of the OE module according to one or more embodiments.

FIG. 2A is a vertical cross-sectional view of an intermediate structure including the fiber array unit according to one or more embodiments.

FIG. 2B is a perspective view of an intermediate structure including the backplate according to one or more embodiments.

FIG. 2C is a vertical cross-sectional view of an intermediate structure including the OE die according to one or more embodiments.

FIG. 2D is a vertical cross-sectional view of an intermediate structure including the socket according to one or more embodiments.

FIG. 3 is a flow chart illustrating a method of forming the OE module according to one or more embodiments.

FIG. 4 is a vertical cross-sectional view of an OE module having a first alternative design according to one or more embodiments.

FIG. 5A is a vertical cross-sectional view of an intermediate structure including the fiber array unit in the first alternative design of the OE module according to one or more embodiments.

FIG. 5B is a vertical cross-sectional view of an intermediate structure including the backplate in the first alternative design of the OE module according to one or more embodiments.

FIG. 5C is a vertical cross-sectional view of an intermediate structure including the OE die in the first alternative design of the OE module according to one or more embodiments.

FIG. 5D is a vertical cross-sectional view of an intermediate structure including the socket in the first alternative design of the OE module according to one or more embodiments.

FIG. 6 is a vertical cross-sectional view of an OE module having a second alternative design according to one or more embodiments.

FIG. 7A is a vertical cross-sectional view of an intermediate structure including the fiber array unit in the second alternative design of the OE module according to one or more embodiments.

FIG. 7B is a vertical cross-sectional view of an intermediate structure including the backplate in the second alternative design of the OE module according to one or more embodiments.

FIG. 7C is a vertical cross-sectional view of an intermediate structure including the OE die in the first alternative design of the OE module according to one or more embodiments.

FIG. 7D is a vertical cross-sectional view of an intermediate structure including the socket in the second alternative design of the OE module according to one or more embodiments.

FIG. 8 is a vertical cross-sectional view of an OE module having a third alternative design according to one or more embodiments.

FIG. 9A is a vertical cross-sectional view of an intermediate structure including the general receptacle on the fiber array unit in the third alternative design of the OE module according to one or more embodiments.

FIG. 9B is a vertical cross-sectional view of an intermediate structure including the backplate in the third alternative design of the OE module according to one or more embodiments.

FIG. 9C is a vertical cross-sectional view of an intermediate structure including the OE die in the third alternative design of the OE module according to one or more embodiments.

FIG. 9D is a vertical cross-sectional view of an intermediate structure including the socket in the third alternative design of the OE module according to one or more embodiments.

FIG. 10 is a vertical cross-sectional view of an OE module having a fourth alternative design according to one or more embodiments.

FIG. 11 is an exploded perspective view of an OE module having a fifth alternative design according to one or more embodiments.

FIG. 12 is a vertical cross-sectional view of a package module according to one or more embodiments.

FIG. 13 is a vertical cross-sectional view of package structure including the package module according to one or more embodiments.

FIG. 14 is a vertical cross-sectional view of a package module having a first alternative design according to one or more embodiments.

FIG. 15 is a vertical cross-sectional view of the package structure having a first alternative design according to one or more embodiments.

FIG. 16 is a vertical cross-sectional view of a package module having a second alternative design according to one or more embodiments.

FIG. 17 is a vertical cross-sectional view of the package structure having a second alternative design according to one or more embodiments.

### DETAILED DESCRIPTION

The following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

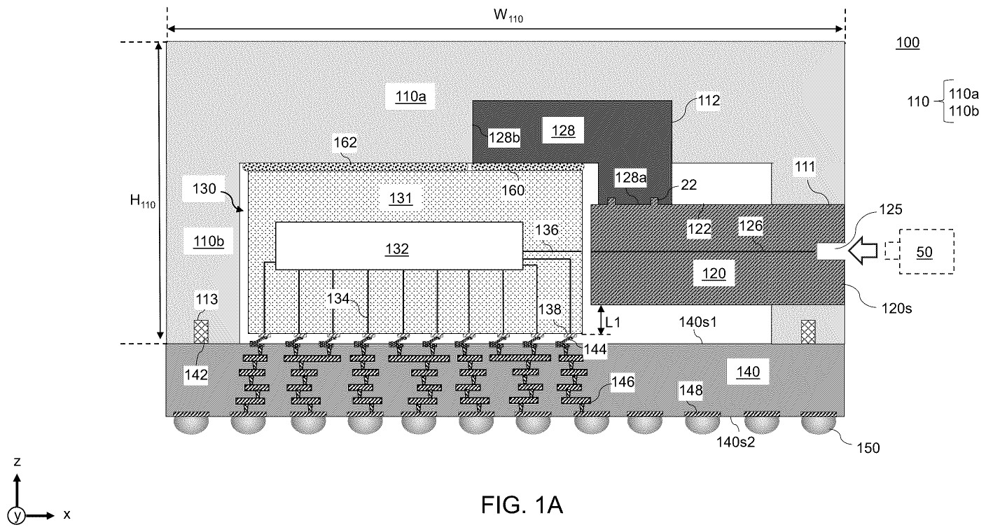

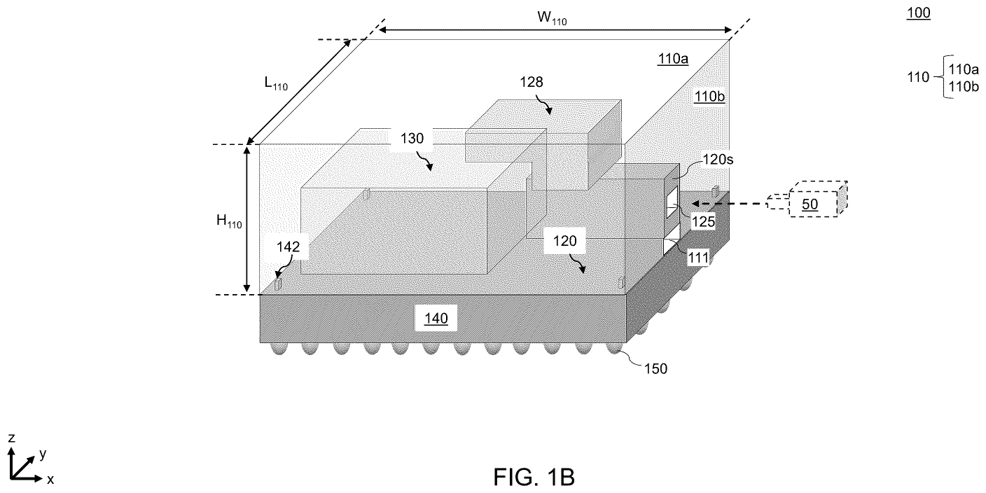

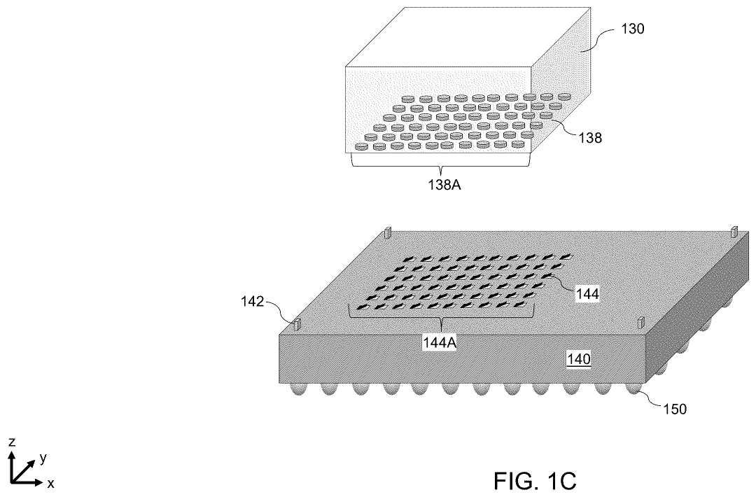

FIGS. 1A-1C are various views of an OE module 100 according to one or more embodiments. FIG. 1A is a vertical cross-sectional view of the OE module 100 according to one or more embodiments. FIG. 1B is a perspective view of the OE module 100 according to one or more embodiments. FIG. 1C is a perspective view of an OE die 130 and socket 140 of the OE module 100 according to one or more embodiments.

As illustrated in FIG. 1A, the OE module 100 may include a backplate 110, a fiber array unit 120 attached to the backplate 110, an optical engine die 130 attached to the backplate 110 adjacent the fiber array unit 120, and a socket 140 (e.g., socket interposer) attached to the backplate 110 and connected to the optical engine die 130.

The OE module 100 may include a compact assembly of optical components designed to perform specific functions related to the manipulation, transmission, and/or detection of light. The OE module 100 may be commonly found in various optical systems and devices, including imaging systems, displays, optical communication systems, and sensors. The OE module 100 may commonly be used in the field of co-packaged optics (CPOs).

The optical components of the OE module 100 may be contained, for example, within the fiber array unit 120 and OE die 130. In particular, the OE module 100 may include a light source (not shown). The light source may include, for example, a laser diode, light-emitting diode (LED), etc. The light source may generate an initial beam of light that is manipulated and guided through an optical system in the OE module 100.

The optical components of the OE module 100 may also include one or more optical lenses, optical mirrors and optical filters and beam splitters. The optical lenses may focus, collimate, or diverge a light beam. The optical mirrors may be used to redirect or fold the light path within the module, enabling compact and efficient optical designs. The optical filters (e.g., bandpass filters, notch filters, polarizing filters, etc.) may selectively transmit or block certain wavelengths or polarization states of light. The beam splitters may divide a light beam in the OE module 100 into multiple beams or combine multiple beams into one and may be used, for example, in interferometry or laser projection systems.

The optical components of the OE module 100 may also include one or more optical waveguides, optical fibers and photodetectors. The optical waveguides may guide light in the OE module 100 and may be used for beam steering, coupling light between different components, or transmitting light over long distances. The optical fibers may also be used to transmit light in the OE module 100. The photodetectors (e.g., photodiodes, phototransistors, etc.) may be used to convert an optical signal into an electrical signal (or vice versa) and for detecting and measuring light intensity, wavelength, or polarization in the OE module 100.

The OE module 100 may also include control electronics (not shown), such as drivers for the light source, signal processing circuits for photodetectors, and feedback mechanisms for controlling the optical components. The control electronics of the OE module 100 may also include microcontrollers or digital signal processors (DSPs) to provide intelligence and control functionality to the module, enabling automation, optimization, or integration with other systems.

As further illustrated in FIG. 1A, the backplate 110 may have a substantially hollow cuboid shape. The backplate 110 may include a plate portion 110a and a sidewall portion 110b projecting downward from the plate portion 110a. The plate portion 110a and the sidewall portion 110b may be integrally formed as a unit, or may be separately formed and connected, for example, by an adhesive (e.g., epoxy adhesive, silicone adhesive, etc.).

The backplate 110 may have a closed design in which the sidewall portion 110b is substantially closed around the periphery of the backplate 110 but include one or more openings. The backplate 110 may alternatively have an open design in which the sidewall portion 110b may include pillars formed at the corners of the plate portion 110a of the backplate 110.

The backplate 110 may have a width W₁₁₀ in the x-direction in a range from 1 mm to 20 mm. The backplate 110 may have a length L₁₁₀ in the y-direction (see FIG. 1B) in a range from 1 mm to 30 mm. The backplate 110 may have a height H₁₁₀ in the z-direction in a range from 0.5 mm to 5.0 mm. Other dimensions are within the contemplated scope of disclosure.

The backplate 110 may be formed of a metal material (e.g., aluminum, steel, etc.), plastic material (e.g., high density polyethylene (HDPE)) or ceramic material. Other suitable materials are within the contemplated scope of disclosure. The backplate 110 may be formed, for example, by machining, stamping, molding (e.g., injection molding), etc. In at least one embodiment, the backplate 110 may be integrally formed as a monolithic structure such as by an injection molding process. Other methods of forming the backplate 110 are within the contemplated scope of disclosure.

The fiber array unit 120 may be located inside the backplate 110. The fiber array unit 120 may be made of materials such as SiO₂, silicon, quartz glass or ceramic materials (e.g., alumina (Al₂O₃), aluminum nitride (AlN), silicon nitride (Si₃N₄), etc.). Polymer materials such as epoxy resins and polyimides may be used as adhesives or bonding materials in the fiber array unit 120.

The fiber array unit 120 may be used to transmit optical signals to and from the optical die 130 in the OE module 100. The fiber array unit 120 may include, for example, a fiber connection port 125 and one or more front-side mirrors (not shown) for directing (redirecting) and/or manipulating optical signals from the fiber connection portion 125. The front-side mirrors may include a high-quality, reflective surface that may be positioned at a specific angle within the fiber array unit 120. The front-side mirrors may be used to perform optical processes such as beam steering, signal routing, or splitting.

The fiber array unit 120 may also include one or more actuators (not shown) to control a position of the front-side mirrors. The actuators may allow for precise adjustments of the mirror's angle, enabling dynamic control of an optical signal path.

The fiber array unit 120 may be enclosed within a housing (not shown) that provides mechanical protection and ensures that the various parts of the fiber array unit 120 are properly aligned and secured. The fiber array unit 120 may also include a microcontroller or microprocessor (not shown) that controls an operation of the fiber array unit 120. In particular, the microcontroller or microprocessor may control the actuators to allow for remote and/or automated control of the position of the front-side mirrors. This is particularly useful in dynamic optical systems.

The fiber array unit 120 with a front-side mirror may be used, for example, in optical switching systems to redirect optical signals to different paths. The fiber array unit 120 may also be used in optical test and measurement systems to adjusting direction of optical beams for testing and alignment. The fiber array unit 120 may also be used in laser systems to control the beam path in laser systems for various applications such as laser cutting and medical procedures. The fiber array unit 120 may also be used in optical communication systems to manage a direction of signals in optical networks or for beamforming in optical antennas.

As illustrated in FIG. 1A, the fiber array unit 120 may include the fiber connection port 125 on a backside 120s of the fiber array unit 120. Optical signals may be input to the OE module 100 and output from the OE module 100 via the fiber connection port 125. The backside 120s of the fiber array unit 120 may be exposed to an outside of the backplate 110. In at least one embodiment, the backside 120s of the fiber array unit 120 may be substantially aligned with an outer surface of the sidewall portion 110b of the backplate 110. In at least one embodiment, the sidewall portion 110b of the backplate 110 may include an opening 111 and the backside 120s of the fiber array unit 120 may be exposed to the outside of the backplate 110 through the opening 111.

The fiber connection port 125 may be configured to detachably receive a multi-fiber push-on/pull-off (MPO) unit 50. The MPO unit 50 may be connected to one or more optical fibers in an optical transmission line. The fiber array unit 120 may also include optical path 126. The fiber connection port 125 may be substantially aligned with the optical path 126 in the fiber array unit 126. Plugging the MPO unit 50 into the fiber connection port 125 may optically couple the optical fibers to the optical path 126 in the fiber array unit 120.

In at least one embodiment, the OE module 100 may include a fiber array unit holder 128. The fiber array unit holder 128 may hold the fiber array unit 120 on the backplate 110. The fiber array unit holder 128 may allow the fiber array unit 120 to be detachable from the OE die 130.

The fiber array unit holder 128 may have a substantially L-shaped cross-section. Other shapes are within the contemplated scope of disclosure. The fiber array unit holder 128 may be formed, for example, of polymer, plastic, ceramic, etc. Other materials are within the contemplated scope of disclosure.

A first end 128a of the fiber array unit holder 128 may be attached to the fiber array unit 120. In at least one embodiment, the first end 128a of the fiber array unit holder 128 may be detachably connected to the fiber array unit 120 by one or more guide pins 22. The guide pins 22 may be formed on an upper surface 122 of the fiber array unit 120 and project into an opening in the first end 128a of the fiber array unit holder 128. The guide pins 22 may allow the fiber array unit 128 to be easily detached from the fiber array unit holder 128. The first end 128a of the fiber array unit holder 128 may alternatively or additionally be attached to the upper surface of the fiber array unit 120 by an adhesive (not shown) such as an epoxy adhesive, silicone adhesive, etc.

A second end 128b of the fiber array unit holder 128 may be located in a recessed portion 112 of the plate portion 110a of the backplate 110. The second end 128b of the fiber array unit holder 128 may also be attached to a surface of the recessed portion 112 by an adhesive (not shown) such as an epoxy adhesive, silicone adhesive, etc. In at least one embodiment, the second end 128b of the fiber array unit holder 128 may be attached to a surface of the recessed portion 112 by an optical gel (e.g., silicone gel) (not shown).

The second end 128b may also be attached by an adhesive layer 160 to the optical engine die 130. The adhesive layer 160 may include an optical gel, epoxy adhesive, silicon adhesive, etc. Other adhesives are within the contemplated scope of disclosure.

As further illustrated in FIG. 1A, the OE die 130 may be located adjacent the fiber array unit 120 and the fiber array unit holder 128. The OE die 130 may be separated from the fiber array unit 120 by a small gap having a length less than about 5 mm to provide a substantially compact design. In at least one embodiment, the OE die 130 may contact the fiber array unit 120. The bottom surface of the OE die 130 may be separated from a bottom surface of the fiber array unit 120 by a distance L1. The distance L1 may not be limited to any particular value, but may used in manufacturing to ensure that the fiber array unit 120 is properly aligned with the OE die 130.

The OE die 130 may also include a substantially cuboid shape. The OE die 130 may be attached to the plate portion 110a of the backplate 110 by an adhesive layer 162. The adhesive layer 162 may include an epoxy adhesive, silicon adhesive, etc. Other adhesives are within the contemplated scope of disclosure.

The OE die 130 may include one or more layers of supporting structure 131. The supporting structure 131 may include, for example, bulk silicon or other suitable materials. The OE die 130 may also include optical engine circuitry 132 in the supporting structure 131. The optical engine circuitry 132 may include, for example, one or more electrical integrated circuits (EICs) and one or more photonic integrated circuits (PICs).

In at least one embodiment, the optical engine circuitry 132 may include various optical components such as a light source (e.g., laser diode, light-emitting diode (LED), etc.), optical lenses, optical mirrors, optical filters and beam splitters, optical waveguides, optical fibers, photodetectors, control electronics (e.g., light source driver circuit, photodetector signal processing circuit, feedback control circuit), microcontrollers, digital signal processors (DSPs), etc. The optical engine circuitry 132 may be connected to electrical wiring 134 (e.g., metal traces, metal vias, etc.) and an optical path 136. The optical path 136 may constitute an optical input/output (I/O) and may be coupled to the one or more PICs in the optical engine circuitry 132. The optical path 136 may include, for example, an optical waveguide, optical fiber, etc. The optical path 136 may be substantially aligned with the optical path 126 in the fiber array unit 120.

The optical engine circuitry 132 may receive optical signals on the optical path 136, convert the optical signals into electrical signals, and transmit the electrical signals via the electrical wiring 134. The optical engine circuitry 132 may receive electrical signals on the electrical wiring 134, convert the electrical signals into optical signals, and transmit the optical signals via the optical path 136.

The OE die 130 may also include a plurality of connector contacts 138 projecting from a bottom surface of the OE die 130. The connector contacts 138 may be formed of a conductive material such as gold, copper, or other suitable metal materials. In at least one embodiment, the connector contacts 138 may be included in connector contact array 138A (see FIG. 1C). The connector contact array 138 may be a 2×2 array of the connector contacts 138 on the bottom surface of the OE die 130.

The connector contacts 138 may include a count of less than about 20,000, a contact density of less than about 50 contacts/mm² and a contact pitch (in the x-direction and y-direction) of less than about 200 μm. The connector contacts 138 may be electrically coupled to the optical engine circuitry 132 by the electrical wiring 134.

As illustrated in FIG. 1A, the socket 140 may include an upper surface 140s1 facing the backplate 110. The upper surface 140s1 may include one or more guide pins 142. In at least one embodiment, the guide pins 142 may be located at least at all four (4) corners of the socket 140. The guide pins 142 may be integrally formed with the body of the socket 140. The guide pins 142 may be inserted into openings 113 formed in the bottom of the sidewall portion 110b of the backplate 110. The guide pins 142 may help to properly align the backplate 110 on the socket 140. The OE module 100 may include a fastening mechanism (not shown) such as a latch or socket set screw to securely attach the backplate 110 to the socket 140.

The socket 140 may be configured to allow for fine pitch attachment. The socket 140 may include a pin-type socket 140 utilizing pins such as probe pins, microelectromechanical (MEMS) pins, etc. In particular, the socket 140 may include a plurality of connector pins 144 in the upper surface 140s1 of the socket 140. The connector pins 144 may project upward toward the OE die 130 from the upper surface 140s1 of the socket 140. The connector pins 144 may be formed of the same material as the connector contacts 138. In particular, the connector pins 144 may be formed of a conductive material such as gold, copper, or other suitable metal materials. In at least one embodiment, the connector pins 144 may be included in connector pin array 144A (see FIG. 1C). The connector pin array 144 may be a 2×2 array of the connector pins 144 on the upper surface 140s1 of the socket 140.

The connector pins 144 may contact the connector contacts 138 of the OE die 130, respectively, to electrically couple the OE die 130 to the socket 140. A secure coupling of the OE die 130 and the socket 140 may be maintained by compression of the connector pins 144 by the connector pads 138, respectively. The connector pins 144 may detachably contact the connector contacts 138 so that the optical engine die 130 may be detachably connected to the socket 140.

The connector pins 144 may have a low profile, with a height less than about 1 mm. The connector pins 144 may have a number, shape and arrangement corresponding to a number, shape and arrangement of the connector contacts 138. In particular, the connector pins 144 may include a pin count of less than about 20,000, a density of less than about 50 openings/mm² and an opening pitch of less than about 200 μm.

The upper surface 140s1 of the socket 140 may have a substantially planar shape. The socket 140 may have a width in the x-direction substantially the same as the width W₁₁₀ of the backplate 110 (e.g., in a range from 1 mm to 20 mm). The socket 140 may have a length in the y-direction substantially the same as the length L₁₁₀ of the backplate 110 (see FIG. 1B). In at least one embodiment, the socket 140 may have a length in the y-direction greater than the length L₁₁₀ of the backplate 110. In at least one embodiment, the socket 140 may have a length in the y-direction in a range from 1 mm to 50 mm. The socket 140 may have a height in the z-direction less than the height H₁₁₀ of the backplate 110. In at least one embodiment, the socket 140 may have a height (including the height of the guide pins 142) less than 50% of the height H₁₁₀ of the backplate 110. In at least one embodiment, the socket 140 may have a height less than 5 mm.

The socket 140 may have a structure similar to an interposer. In at least one embodiment, the socket 140 may include one or more dielectric layers (e.g., silicon oxide layers). The socket 140 may include one or more interconnect structures 146 formed in the dielectric layers. The interconnect structures 146 may be formed of one or more layers of metals, metal alloys, and/or or other metal-containing compounds (e.g., Cu, Al, Mo, Co, Ru, W, Cr, Ni, Sn, Ti, Ta, Au, TiN, TaN, WN, etc.). The interconnect structures 146 may include, for example, a plurality of metal traces (e.g., copper traces) and metal vias (e.g., copper vias). The interconnect structures 146 may be electrically coupled to the connector pins 144.

The socket 140 may also include a plurality of contact pads 148 formed on a lower surface 140s2 of the socket 140. The contact pads 148 may also include one or more layers of metals, metal alloys, and/or or other metal-containing compounds (e.g., Cu, Al, Mo, Co, Ru, W, Cr, Ni, Sn, Ti, Ta, Au, TiN, TaN, WN, etc.). A ball-grid array (BGA) including a plurality of solder balls 150 may be formed on the contact pads 148 on the lower surface 140s2.

The interconnect structures 146 may electrically couple to the connector pins 144 to the contact pads 148 and the BGA on the lower surface 140s2 of the socket 140. The OE die 130 may, therefore, be electrically coupled to the BGA via the connector contacts 138 of the OE die 130 and the connector pins 144 of the socket 140.

With this configuration, the socket 140 may provide an input/output (I/O) function, allowing the OE module 100 to be mounted on a substrate (e.g., package substrate, interposer, redistribution layer (RDL) structure) and transmit data to the substrate an receive data from the substrate through the BGA. The socket 140 may allow components of the OE module 110 including the backplate 110, the fiber array unit 120, and the OE die 130 to be removably connected to the substrate. The socket 140 may allow the OE die 130 to be easily exchanged without impacting a function of other dies (e.g., ASIC die) on the substrate.

It should be noted that other means of detachably connecting the OE die 130 to the socket 140. In particular, a connector pin array including a plurality of connector pins may be formed on the bottom surface of the OE die 130. The connector pins 138 may include, for example, a probe pin, a microelectromechanical system (MEMS) pin, pogo pins, etc. A connector pin opening array including a plurality of connector pins may be formed on the upper surface 140s1 of the socket 140. The connector pins may be inserted into the connector pin openings in order to detachably couple the OE die 130 to the socket 140.

In at least one embodiment, the socket 140 may have a structure and function substantially similar to a central processing unit (CPU) socket. The socket 140 may include, for example, retention clips that apply a constant force, which must be overcome when the connector pins 138 of the OE die 130 are inserted. The socket 140 may include a zero insertion force (ZIF) socket. The socket 140 may also include a pin grid array (PGA) type socket or land grid array (LGA) type socket. In embodiments in which the OE module 100 includes a latch, after the connector contacts 138 are positioned on the connector pins 144, the latch may be closed to secure the backplate 110 to the socket 140. This may help to maintain a compressive force by the connector contacts 138 on the connector pins 144, thereby providing a good connection and mechanical stability between the connector contacts 138 on the connector pins 144.

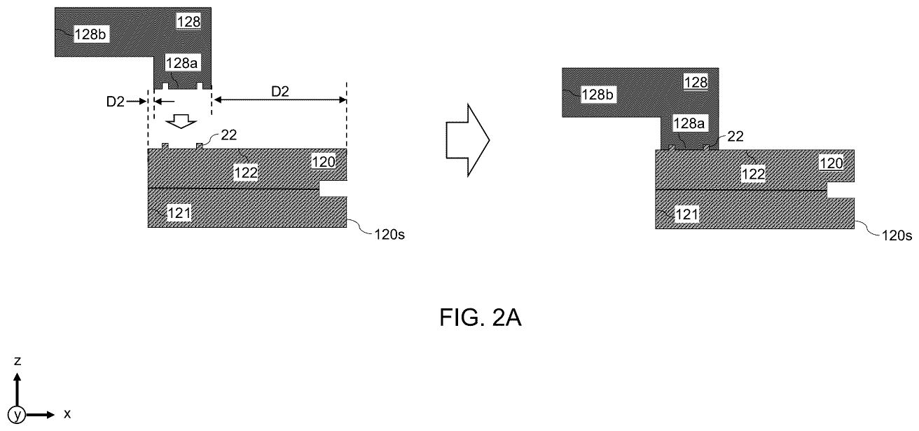

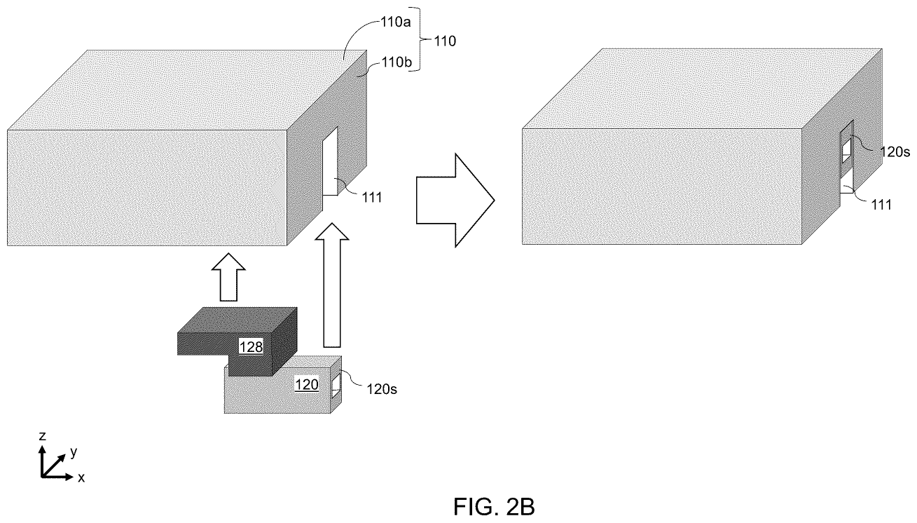

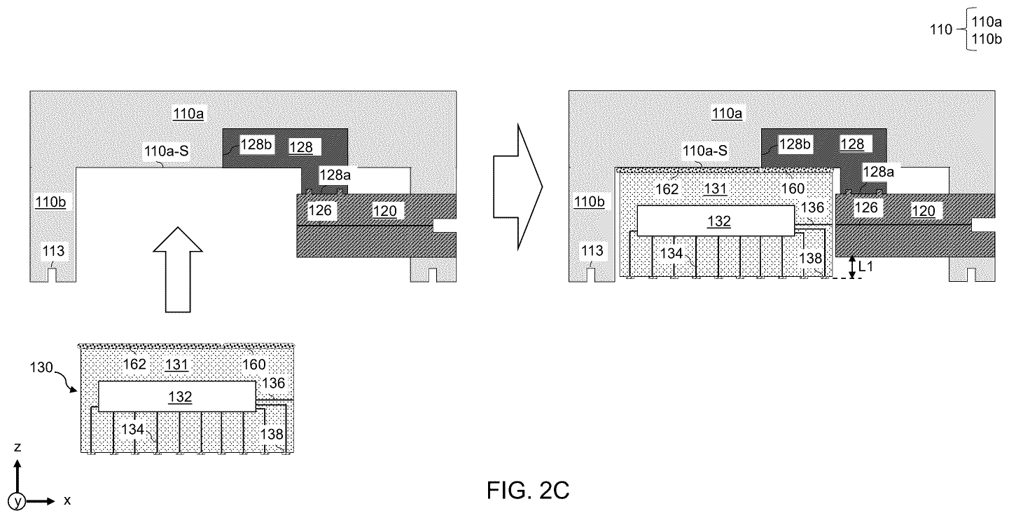

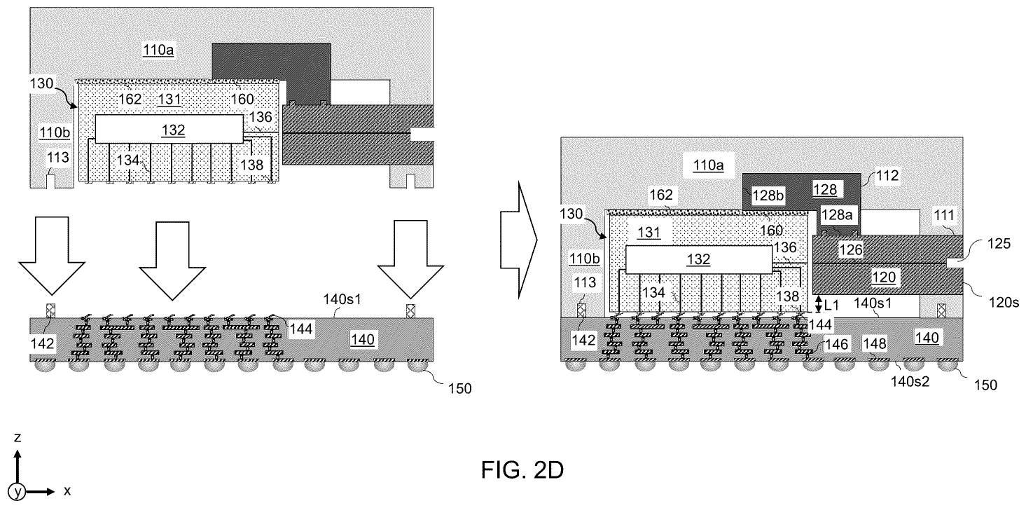

FIGS. 2A-2D illustrate various intermediate structures that may be formed in a method of making the OE module 100 according to one or more embodiments. FIG. 2A is a vertical cross-sectional view of an intermediate structure including the fiber array unit 120 according to one or more embodiments. It should be noted that various components may be located or positioned in the method using an electromechanical pick-and-place (PnP) machine.

In the method of making the OE module 100, the fiber array unit holder 128 may be positioned over the fiber array unit 120 so that the guide pins 22 are substantially aligned with the openings in the fiber array unit holder 128. The first end 128a of the fiber array unit holder 128 may be separated in the x-direction from the front side 121 of the fiber array unit 120 by a first distance D1. The first end 128a of the fiber array unit holder 128 may be separated in the x-direction from the backside 120s of the fiber array unit 120 by a second distance D2. The first distance D1 may be less than the second distance D2. In at least one embodiment, the first distance D1 may be less than 20% of the second distance D2.

The first end 128a of the fiber array unit holder 128 may then be pressed onto the upper surface 122 of the fiber array unit 120 through the adhesive layer. The fiber array unit holder 128 may therefore be attached to the fiber array unit 120 without the use of the adhesive layer.

An adhesive layer (not shown) (e.g., epoxy adhesive, silicone adhesive, etc.) may be additionally or alternatively applied to the first end 128a of the fiber array unit holder 128 and/or the upper surface 122 of the fiber array unit 120. The first end 128a of the fiber array unit holder 128 may then be placed in contact with the upper surface 122 of the fiber array unit 120 through the adhesive layer. The fiber array unit holder 128 may then be clamped onto the fiber array unit 120 until the adhesive layer is cured.

FIG. 2B is a vertical cross-sectional view of an intermediate structure including the backplate 110 according to one or more embodiments. As illustrated in FIG. 2B, the fiber array unit 120 with the attached fiber array unit holder 128 may be inserted into the backplate 110. In particular, the fiber array unit 120 may be inserted in the opening 111 in the sidewall portion 110b of the backplate 110.

The fiber array unit 120 may be inserted into the opening 111 such that the backside 120s of the fiber array unit 120 may be substantially aligned with an outer surface of the sidewall portion 110b of the backplate 110. In particular, the fiber array unit 120 may be inserted into the opening 111 such that the backside 120s of the fiber array unit 120 may be exposed to the outside of the backplate 110 through the opening 111. In at least one embodiment, the upper surface 122 of the fiber array unit 120 may contact an upper surface of the opening 111.

An optional adhesive layer (not shown) (e.g., epoxy adhesive, silicone adhesive, etc.) may be applied to an upper surface of the fiber array unit holder 128 and/or to the recessed portion 112 in the plate portion 110a of the backplate 110. As the fiber array unit 120 is being inserted into the opening 111, the fiber array unit holder 128 may be inserted into the recessed portion 112 in the plate portion 110a of the backplate 110 (see FIG. 1A). The fiber array unit holder 128 and or the fiber array unit 120 may then be clamped to the backplate 110 until the adhesive layer is cured.

FIG. 2C is a vertical cross-sectional view of an intermediate structure including the OE die 130 according to one or more embodiments. As illustrated in FIG. 2C, the adhesive layer 160 and the adhesive layer 162 may be applied to an upper surface of the OE die 130. The adhesive layer 160 and the adhesive layer 162 may be formed as a single layer. The adhesive layer 160 and the adhesive layer 162 may be formed of the same material and have substantially the same cure rate.

A thickness of the adhesive layer 160 may be substantially the same as a thickness of the adhesive layer 162. A bottom surface 110a-S of the plate portion 110a of the backplate 110 may be substantially coplanar with a bottom surface of the second end 128b of the fiber array unit holder 128. The OE die 130 may then be pressed into position on the bottom surface 110a-S of the plate portion 110a. The OE die 130 may then be clamped onto the backplate 110 until the adhesive layer 160 and the adhesive layer 162 are cured. The second end 128b of the fiber array unit holder 128 may, therefore, be attached to the OE die 130 by the adhesive layer 160. The bottom surface 110a-S of the plate portion 110a may be attached to the OE die 130 by the adhesive layer 162.

The OE die 130 may be attached to the plate portion 110a and the fiber array unit holder 128 so as to be substantially coplanar with the fiber array unit 120. In particular, the optical path 136 of the OE die 130 may be made to be substantially aligned with the optical path 126 in the fiber array unit 120 (e.g., see FIG. 1A). This may be satisfied, for example, by visual inspection to ensure that the distance between the bottom surface of the OE die 130 and the bottom surface of the fiber array unit 120 is set to the specified distance L1 (see FIG. 1A).

FIG. 2D is a vertical cross-sectional view of an intermediate structure including the socket 140 according to one or more embodiments. As illustrated in FIG. 2D, after the adhesive layer 160 and the adhesive layer 162 have cured, the backplate 110 including the attached OE die 130 may be connected (e.g., detachably connected) to the socket 140. First, the backplate 110 may be positioned over the socket 140 so that the guide pins 142 on the upper surface 140s1 of the socket 140 may be substantially aligned with the openings 113 in the sidewall portion 110b of the backplate 110. By aligning the guide pins 142 with the openings 113 the connector contacts 138 on the OE die 130 may be assured of engaging the connector pins 144 in the upper surface 140s1 of the socket 140. The backplate 110 may then be pressed firmly onto the socket 140 so that the connector contacts 138 contact the connector pins 144, and the OE die 130 is electrically coupled to the socket 140. The backplate 110 may then be securely attached to the socket 140 using a fastening mechanism (not shown) such as a latch or socket set screw.

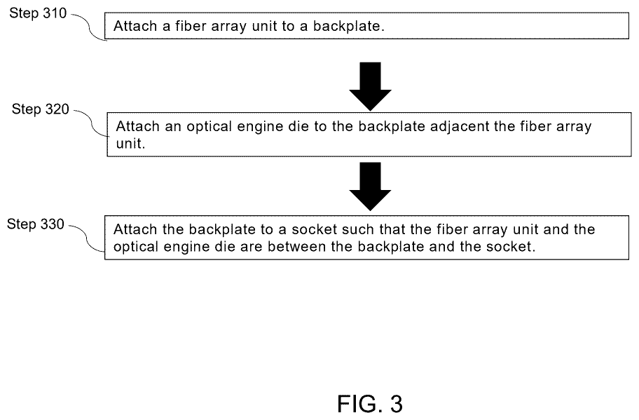

FIG. 3 is a flow chart illustrating a method of forming the OE module 100 according to one or more embodiments. Step 310 of the method may include attaching a fiber array unit to a backplate. Step 320 may include attaching the optical engine die to the backplate adjacent the fiber array unit. Step 330 may include attaching the backplate to a socket such that the fiber array unit and the optical engine die are between the backplate and the socket.

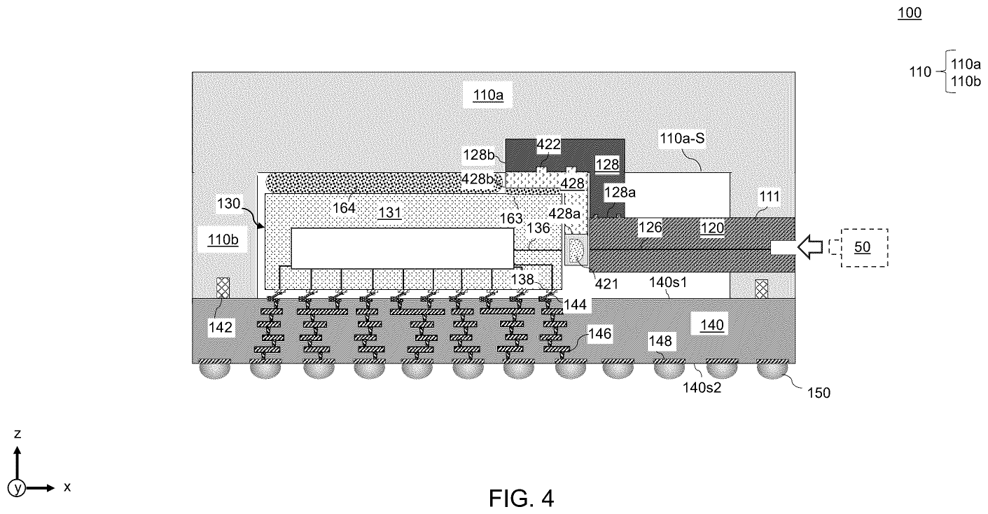

FIG. 4 is a vertical cross-sectional view of an OE module 100 having a first alternative design according to one or more embodiments. As illustrated in FIG. 4, the OE module 100 having the first alternative design may be substantially the same as the OE module 100 in FIGS. 1A-1C. However, the first alternative design may differ from the OE module 100 in FIGS. 1A-1C in that the first alternative design may include a microlens receptacle 428.

The microlens receptacle 428 may be located between the fiber array unit holder 128 and the OE die 130. Similar to the design in FIGS. 1A-1C, the fiber array unit holder 128 may be located in the recessed portion 112 of the plate portion 110a of the backplate 110. The fiber array unit holder 128 may be alternatively attached to the bottom surface 110a-S of the plate portion 110a of the backplate 110. In either case, the fiber array unit holder 128 may be attached by using an adhesive layer (not shown) such as glue, optical gel, epoxy adhesive, silicone adhesive, etc.

The microlens receptacle 428 may have a shape that substantially corresponds to a shape of the fiber array unit holder 128. In at least one embodiment, the microlens receptacle 428 may be substantially L-shaped. The microlens receptacle 428 may be made of the same material as the fiber array unit holder 128 (e.g., polymer, plastic, ceramic, etc.). Other materials may be within the contemplated scope of disclosure.

The microlens receptacle 428 may have a first end 428a between the fiber array unit 120 and the OE die 130. The microlens receptacle 428 may have a second end 428b between the fiber array unit holder 128 and the OE die 130. The second end 428b may be substantially aligned with the second end 128b of the fiber array unit holder 128. The second end 428b may be attached to OE die 130 by an adhesive layer 163. The OE die 130 may also be attached to the bottom surface 110a-S of the plate portion 110a of the backplate 110 by an adhesive layer 164. The adhesive layer 164 may have a thickness greater than a thickness of the adhesive layer 163. In particular, the thickness of the adhesive layer 164 may be substantially equal to a combined thickness of the microlens receptacle 428 and the adhesive layer 163. Each of the adhesive layer 163 and the adhesive layer 164 may include an optical gel (e.g., silicone gel), or an epoxy adhesive, silicon adhesive, etc. Other adhesives are within the contemplated scope of disclosure.

The microlens receptacle 428 may include a microlens 421 at the first end 428a of the microlens receptacle 428. The microlens 421 may be formed in a light transmissive material (e.g., Fused Silica, Sapphire, Germanium, Zinc Selenide, Calcium Fluoride, and Magnesium Fluoride) that is attached (e.g., by an adhesive layer) to the first end 428a of the microlens receptacle 428. The microlens 421 may be positioned to be substantially aligned with the optical path 126 in the fiber array unit 120 and the optical path 136 in the OE die 130. Optical components other than the microlens 421 may alternatively or additionally be included in the microlens receptacle 428. The microlens 421 may collimate, diverge or focus light into an optical path 136.

The microlens receptacle 428 may include one or more guide pins 422 to ensure that the microlens receptacle 428 is properly positioned on the fiber array unit holder 128. The guide pins 422 may be inserted into one or more recessed portions in the fiber array unit holder 128. The microlens receptacle 428 may have a size that is smaller than a size of the fiber array unit holder 128.

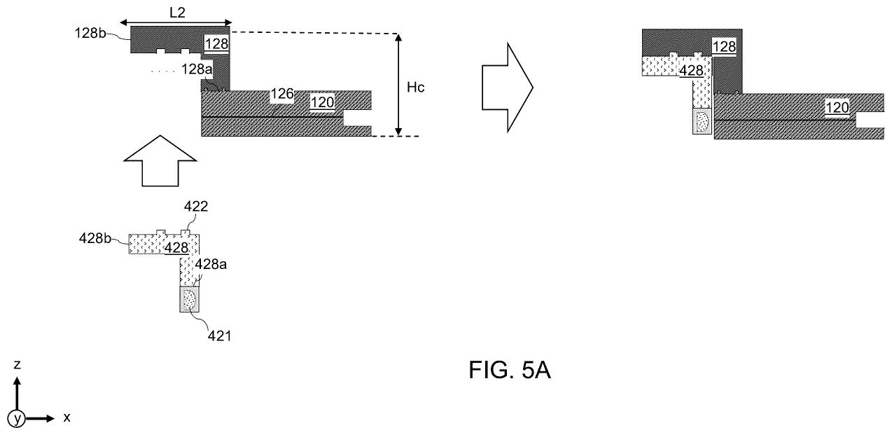

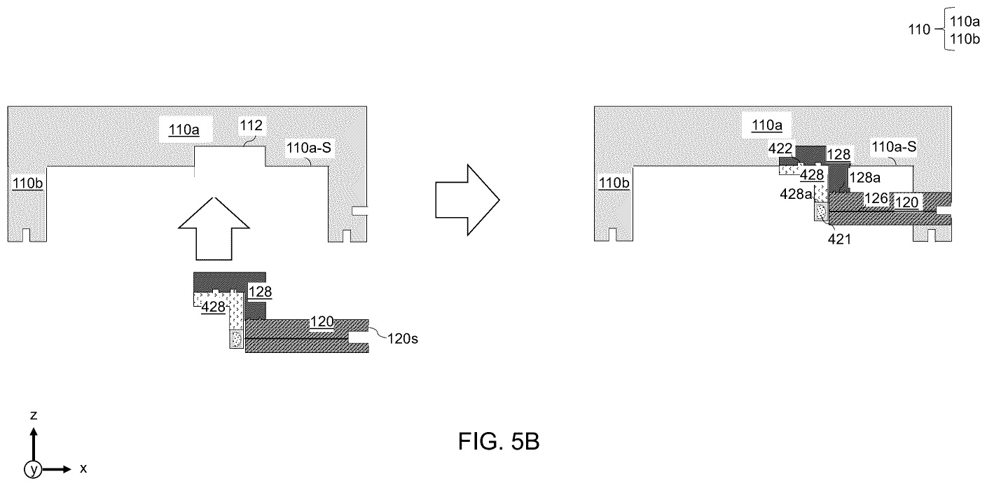

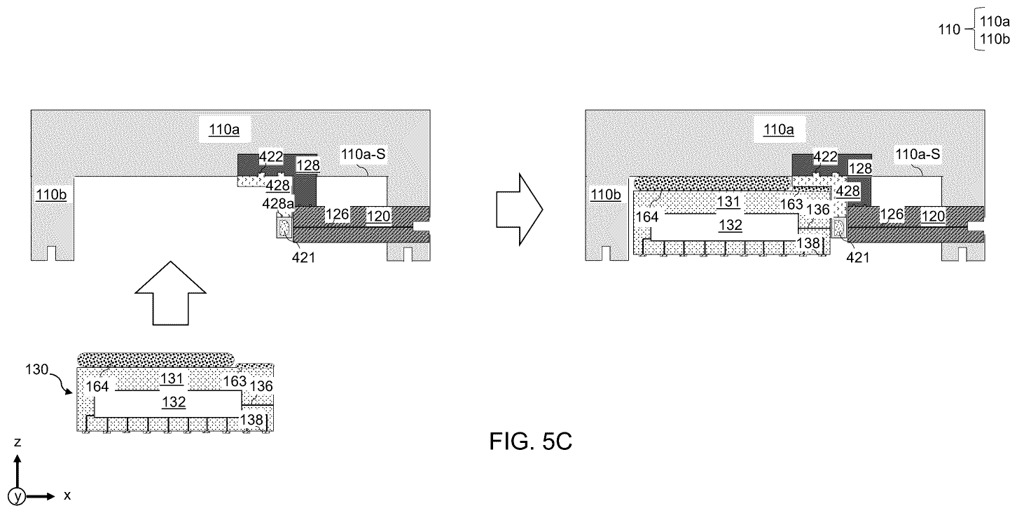

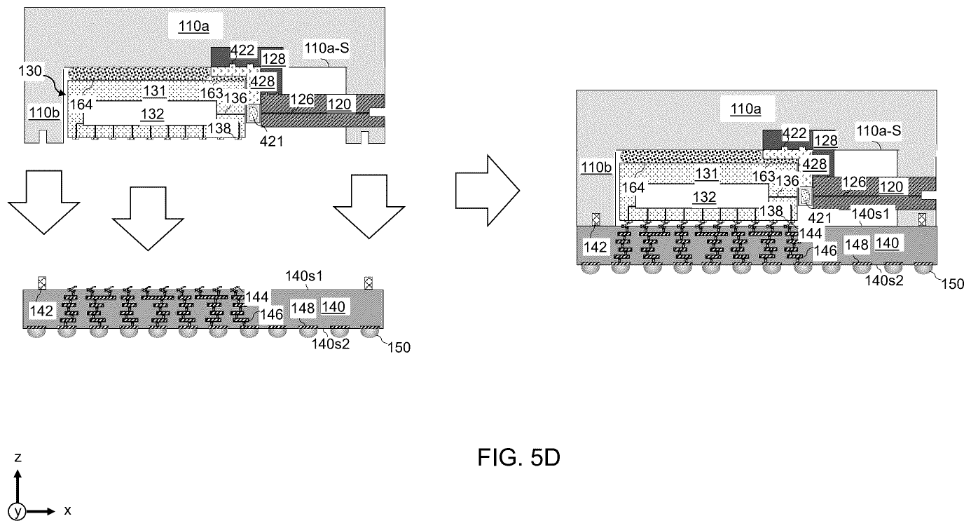

FIGS. 5A-5D illustrate various intermediate structures that may be formed in a method of making the OE module 100 having the first alternative design according to one or more embodiments. It should be noted that various components may be located or positioned in the method using an electromechanical pick-and-place (PnP) machine.

FIG. 5A is a vertical cross-sectional view of an intermediate structure including the fiber array unit 120 in the first alternative design of the OE module 100 according to one or more embodiments.

Similar to the design in FIGS. 1A-1C, in the first alternative design, the fiber array unit holder 128 may be attached (e.g., by an adhesive layer (not shown)) or detachably connected (e.g., by guide pins (not shown)) to the fiber array unit 120. The microlens receptacle 428 may then be positioned under the fiber array unit holder 128. In particular, the guide pins 422 of the microlens receptacle 428 may the substantially aligned with the recessed portions of the fiber array unit holder 128. An optional adhesive layer (e.g., epoxy adhesive, silicone adhesive) may be applied to an upper surface of the microlens receptacle 428.

The second end 428b of the microlens receptacle 428 may then be pressed onto the underside of the fiber array unit holder 128. The guide pins 422 on the microlens receptacle 428 may be inserted into the recessed portions of the fiber array unit holder 128. The microlens 421 at the first end 428a of the microlens receptacle 428 may be positioned so as to be substantially aligned with the optical path 126 of the fiber array unit 120.

As illustrated in FIG. 5A, the fiber array unit holder 128 may have a length L2 in the x-direction in a range from 3 mm to 6 mm. The fiber array unit holder 128 may also have a length in the y-direction in a range from 3 mm to 18 mm. A combined height Hc in the z-direction of the fiber array unit 120 and the fiber array unit holder 128 may be in a range from 0.5 mm to 1 mm.

FIG. 5B is a vertical cross-sectional view of an intermediate structure including the backplate 110 in the first alternative design of the OE module 100 according to one or more embodiments. An optional adhesive layer (e.g., optical gel, epoxy adhesive, silicone adhesive, etc.) may be applied to the recessed portion 112 or to an upper surface of the fiber array unit holder 128. The fiber array unit 120 with the attached fiber array unit holder 128 and the attached microlens receptacle 428 may then be inserted into the recessed portion 112. The fiber array unit 120 may also be inserted in the opening 111 in the sidewall portion 110b of the backplate 110 (e.g., see FIG. 1B).

The fiber array unit 120 may be inserted into the opening 111 such that the backside 120s of the fiber array unit 120 may be substantially aligned with an outer surface of the sidewall portion 110b of the backplate 110. As the fiber array unit 120 is being inserted into the opening 111, the fiber array unit holder 128 may be pressed into the recessed portion 112 in the bottom surface 110a-S of the plate portion 110a of the backplate 110. The fiber array unit holder 128 and/or the fiber array unit 120 may then be clamped to the backplate 110 until the optional adhesive layer (if applicable) is cured.

FIG. 5C is a vertical cross-sectional view of an intermediate structure including the OE die 130 in the first alternative design of the OE module 100 according to one or more embodiments. As illustrated in FIG. 5C, the adhesive layer 163 and the adhesive layer 164 may be applied to an upper surface of the OE die 130. The OE die 130 may then be pressed into position on the bottom surface of the microlens receptacle 428. The OE die 130 may then be clamped onto the microlens receptacle 428 until the adhesive layer 163 and the adhesive layer 164 are cured. The second end 428b of the microlens receptacle 428 may, therefore, be attached to the OE die 130 by the adhesive layer 163. The OE die 130 may be attached to the microlens receptacle 428 so as to be substantially coplanar with the fiber array unit 120.

FIG. 5D is a vertical cross-sectional view of an intermediate structure including the socket 140 in the first alternative design of the OE module 100 according to one or more embodiments. As illustrated in FIG. 5D, after the adhesive layer 163 and the adhesive layer 164 have cured, the backplate 110 including the attached OE die 130 may be attached to the socket 140. The backplate 110 may be positioned over the socket 140 so that the guide pins 142 on the upper surface 140s1 of the socket 140 may be substantially aligned with the openings 113 in the sidewall portion 110b of the backplate 110. The backplate 110 may then be pressed firmly onto the socket 140 so that the connector contacts 138 firmly contact the connector pins 144, and the OE die 130 is electrically coupled to the socket 140. The backplate 110 may then be securely attached to the socket 140 using a fastening mechanism (not shown) such as a latch or socket set screw.

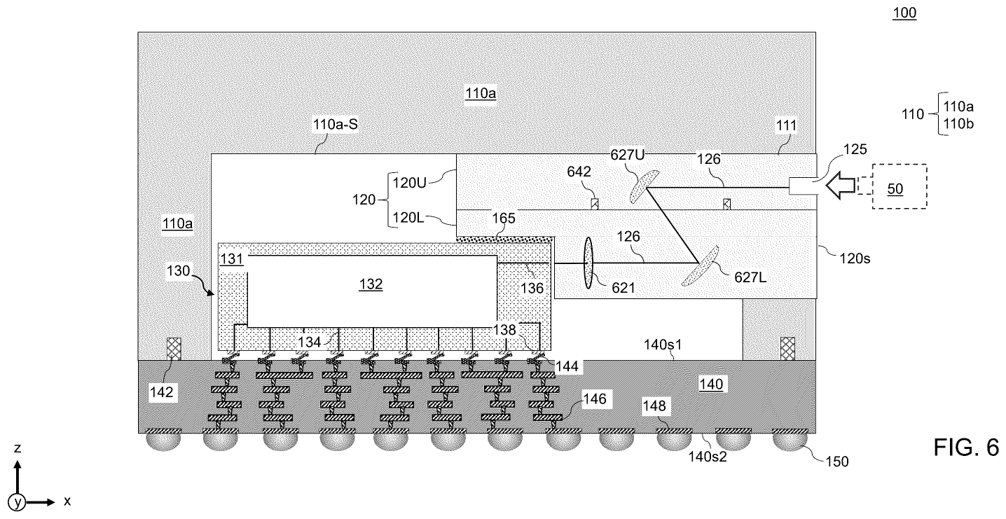

FIG. 6 is a vertical cross-sectional view of an OE module 100 having a second alternative design according to one or more embodiments. As illustrated in FIG. 6, the OE module 100 having the second alternative design may be substantially the same as the OE module 100 in FIGS. 1A-1C. However, the second alternative design may differ from the OE module 100 in FIGS. 1A-1C in that the second alternative design may omit the fiber array unit holder 128.

In the second alternative design, the fiber array unit 120 may include a fiber array unit upper portion 120U (e.g., upper optics unit) and a fiber array unit lower portion 120L (e.g., lower optics unit). Both the fiber array unit upper portion 120U and the fiber array unit lower portion 120L may be formed in the opening 111 in the sidewall portion 110b of the backplate 110. An upper wall of the opening 111 in the second alternative design may also constitute the bottom surface 110a-S of the plate portion 110a of the backplate 110.

The fiber array unit upper portion 120U may be detachably connected to the fiber array unit lower portion 120L by one or more guide pins 642. The fiber array unit 120 may be easily damaged by an assembly process and the detachable function may help to allow the fiber array unit 120 to be conveniently replaced.

The guide pins 642 may be formed on the fiber array unit lower portion 120L and inserted into openings in the fiber array unit upper portion 120U. The guide pins 642 may alternatively or additionally be formed on the fiber array unit upper portion 120U and inserted into openings in the fiber array unit lower portion 120L.

The optical path 126 may extend from the fiber connection port 125 on the backside 120s of the fiber array unit 120 to the interface (e.g., gapped interface) with the OE die 130. The fiber array unit 120 may also include one or more optical components in the optical path 126. In particular, the fiber array unit 120 may include an upper optical mirror 627U (e.g., reflective mirror) in the fiber array unit upper portion 120U, and a lower optical mirror 627L (e.g., reflective mirror) and an optional lens 621 (e.g., microlens) in the fiber array unit lower portion 120L. The optical mirror 627L may be configured to direct an optical signal from the fiber array unit upper portion 120U into the OE die 130 and direct an optical signal from the OE die 130 into the fiber array unit upper portion 120U.

The fiber connection portion 125 may be located in the fiber array unit upper portion 120U and the optical path 126 may extend from the fiber connection portion 125 to the upper optical mirror 627U, the lower optical mirror 627L and lens 621, in that order. The optical path 126 from the lower optical mirror 627L through microlens 621 may be substantially aligned with the optical path 136 of the OE die 130. The optical path 126 may alternatively or additionally include other optical components such as optical lenses, optical mirrors, optical filters and beam splitters, optical waveguides, optical fibers, etc. In particular, at least some portion of the optical path 126 may be formed by an optical fiber (e.g., bending optical fiber).

The fiber array unit 120 may be attached to the bottom surface 110a-S of the plate portion 110a of the backplate 110 by an adhesive layer (not shown). The adhesive layer may include an optical gel (e.g., silicone gel), or an epoxy adhesive, silicon adhesive, etc. Other adhesives are within the contemplated scope of disclosure.

The fiber array unit 120 may also be attached to an upper surface of the OE die 130 by an adhesive layer 165. The adhesive layer 165 may include an optical gel (e.g., silicone gel), or an epoxy adhesive, silicon adhesive, etc. Other adhesives are within the contemplated scope of disclosure. The fiber array unit 120 may have a height in the z-direction in a range from 0.5 mm to 1.0 mm. The fiber array unit 120 may have a width in the x-direction in a range from 3 mm to 8 mm. The fiber array unit 120 may have a length in the y-direction in a range from 1 mm to 18 mm.

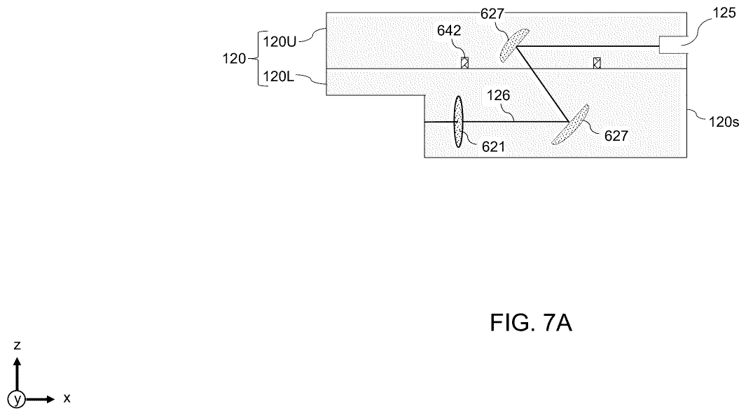

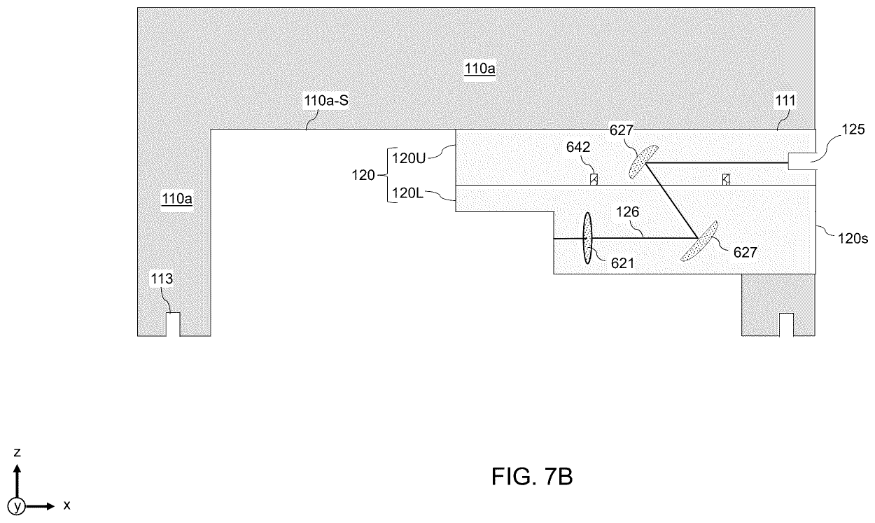

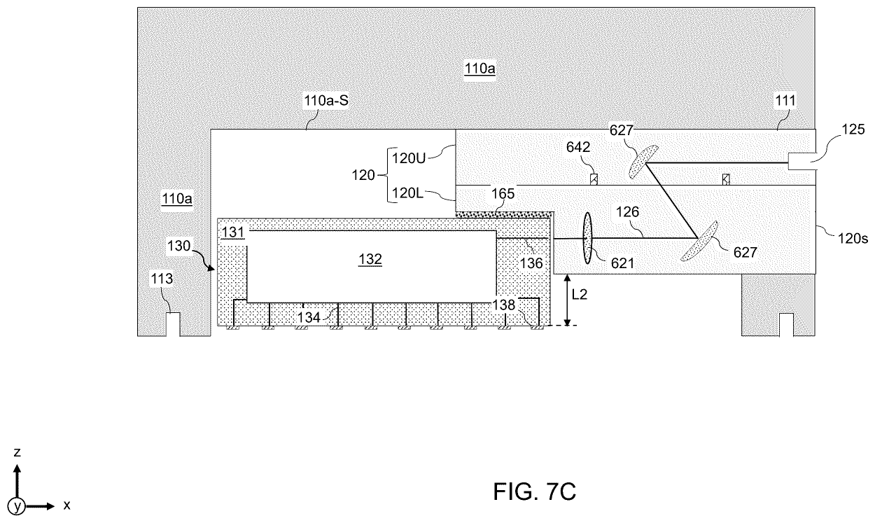

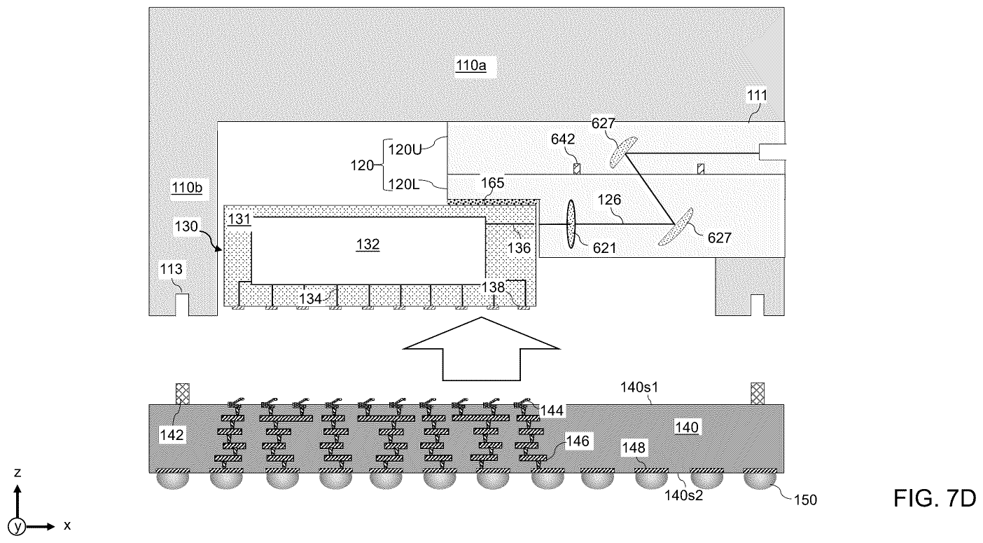

FIGS. 7A-7D illustrate various intermediate structures that may be formed in a method of making the OE module 100 having the second alternative design according to one or more embodiments. It should be noted that various components may be located or positioned in the method using an electromechanical pick-and-place (PnP) machine.

FIG. 7A is a vertical cross-sectional view of an intermediate structure including the fiber array unit 120 in the second alternative design of the OE module 100 according to one or more embodiments. The fiber array unit 120 may be assembled by attaching the fiber array unit upper portion 120U to the fiber array unit lower portion 120L. In particular, the fiber array unit upper portion 120U may be pressed onto the fiber array unit lower portion 120L so that the guide pins 642 on the upper surface of the fiber array unit lower portion 120L are inserted into the respective openings in the fiber array unit upper portion 120U.

The optional adhesive layer (not shown) may be alternatively or additionally applied to the fiber array unit lower portion 120L. In this case, the fiber array unit upper portion 120U may be pressed onto the adhesive layer. The adhesive layer may then be cured to complete assembly of the fiber array unit 120.

FIG. 7B is a vertical cross-sectional view of an intermediate structure including the backplate 110 in the second alternative design of the OE module 100 according to one or more embodiments. The optional adhesive layer (not shown) (e.g., optical gel, epoxy adhesive, silicone adhesive, etc.) may be applied to an upper surface of the fiber array unit 120. The fiber array unit 120 may then be inserted into the backplate 110. In particular, the fiber array unit 120 may be inserted in the opening 111 in the sidewall portion 110b of the backplate 110.

The fiber array unit 120 may be inserted into the opening 111 such that the backside 120s of the fiber array unit 120 may be substantially aligned with an outer surface of the sidewall portion 110b of the backplate 110. As the fiber array unit 120 is being inserted into the opening 111, the fiber array unit 120 may attached to the bottom surface 110a-S of the plate portion 110a of the backplate 110. The fiber array unit 120 may then be clamped to the backplate 110 until the optional adhesive layer is cured.

FIG. 7C is a vertical cross-sectional view of an intermediate structure including the OE die 130 in the first alternative design of the OE module 100 according to one or more embodiments. As illustrated in FIG. 7C, the adhesive layer 165 may be applied to the upper surface of the OE die 130. The OE die 130 may then be pressed into position on the bottom surface of the fiber array unit 120. The OE die 130 may then be clamped onto the fiber array unit 120 until the adhesive layer 165 is cured.

The OE die 130 may be attached to the fiber array unit 120 so as to be substantially coplanar with the fiber array unit 120. In particular, the optical path 136 of the OE die 130 may be made to be substantially aligned with the optical path 126 in the fiber array unit 120. This may be satisfied, for example, by visual inspection to verify the distance between the bottom surface of the OE die 130 and the bottom surface of the fiber array unit 120 is set to the specified distance L2.

FIG. 7D is a vertical cross-sectional view of an intermediate structure including the socket 140 in the second alternative design of the OE module 100 according to one or more embodiments. As illustrated in FIG. 7D, after the adhesive layer 165 has cured, the backplate 110 including the attached OE die 130 may be attached to the socket 140. The backplate 110 may be positioned over the socket 140 so that the guide pins 142 on the upper surface 140sl of the socket 140 may be substantially aligned with the openings 113 in the sidewall portion 110b of the backplate 110. The backplate 110 may then be pressed firmly onto the socket 140 so that the connector contacts 138 firmly contact the connector pins 144, and the OE die 130 is electrically coupled to the socket 140. The backplate 110 may then be securely attached to the socket 140 using a fastening mechanism (not shown) such as a latch or socket set screw.

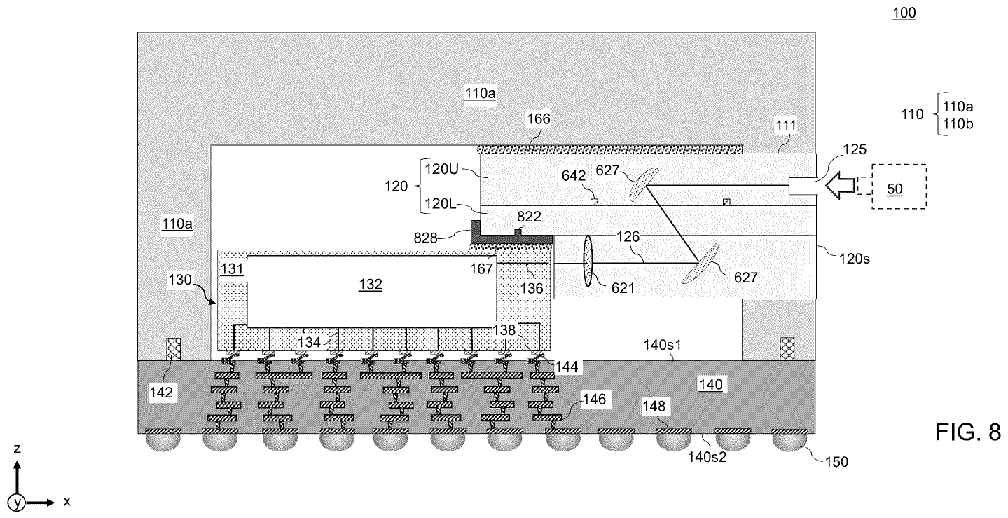

FIG. 8 is a vertical cross-sectional view of an OE module 100 having a third alternative design according to one or more embodiments. As illustrated in FIG. 8, the OE module 100 having the third alternative design may be substantially the same as the OE module 100 in FIG. 6. However, the third alternative design may differ from the OE module 100 in FIG. 6 in that the third alternative design may include a general receptacle 828.

In the third alternative design, the fiber array unit 120 may be substantially the same as the fiber array unit 120 in the second alternative design. The fiber array unit 120 may be located in the opening 111 in the sidewall portion 110b of the backplate 110. The fiber array unit 120 may be attached to the bottom surface 110a-S of the plate portion 110a of the backplate 110 by an adhesive layer 166. The adhesive layer 166 may include an optical gel (e.g., silicone gel), or an epoxy adhesive, silicon adhesive, etc. Other adhesives are within the contemplated scope of disclosure.

The general receptacle 828 may be located between the fiber array unit 120 and the upper surface of the OE die 130. The general receptacle 828 may be substantially L-shaped. The general receptacle 828 may be made of the same material as the microlens receptacle 428 and the same material as the fiber array unit holder 128 (e.g., polymer, plastic, ceramic, etc.). Other materials may be within the contemplated scope of disclosure.

The general receptacle 828 may have a short side located along an end of the fiber array unit lower portion 120L and a long side located between the fiber array unit 120 and the OE die 130. The general receptacle 828 may be attached to OE die 130 by an adhesive layer 167. The adhesive layer 167 may include an optical gel (e.g., silicone gel), or an epoxy adhesive, silicon adhesive, etc. Other adhesives are within the contemplated scope of disclosure.

The long side of the general receptacle 828 may include one or more guide pins 822 to ensure that the general receptacle 828 is properly positioned on the fiber array unit 120. The guide pins 422 may be inserted into one or more recessed portions in the fiber array unit lower portion 120L.

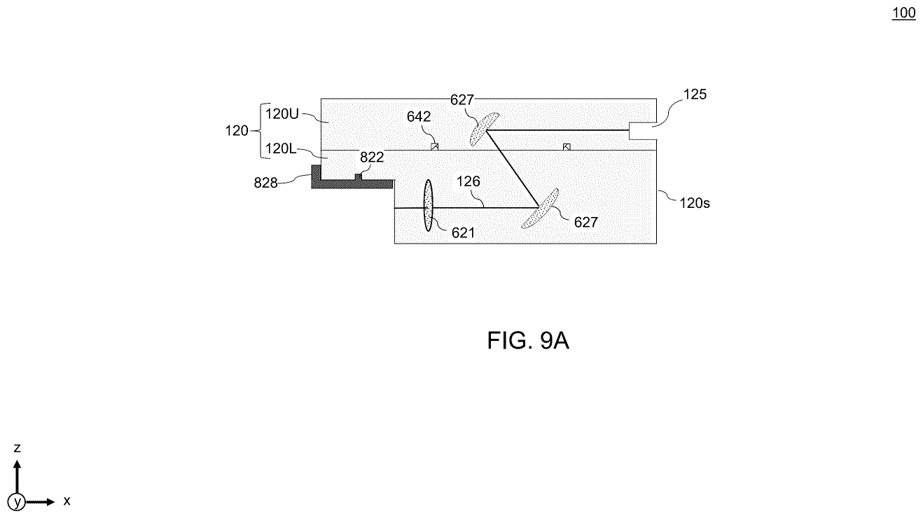

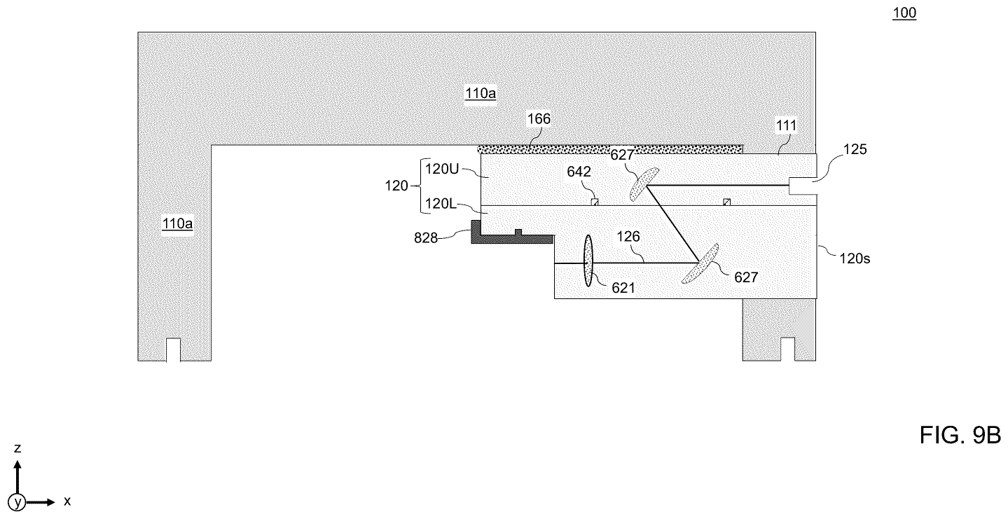

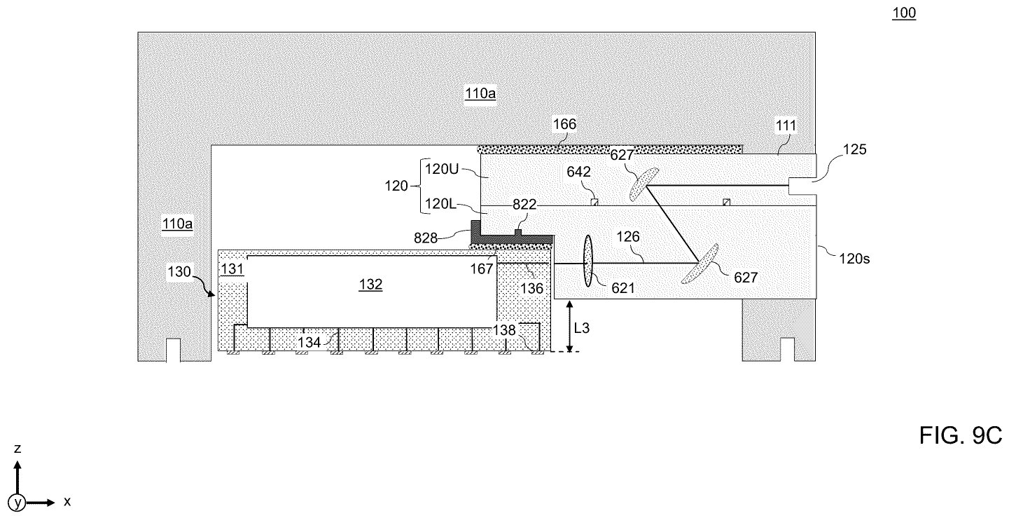

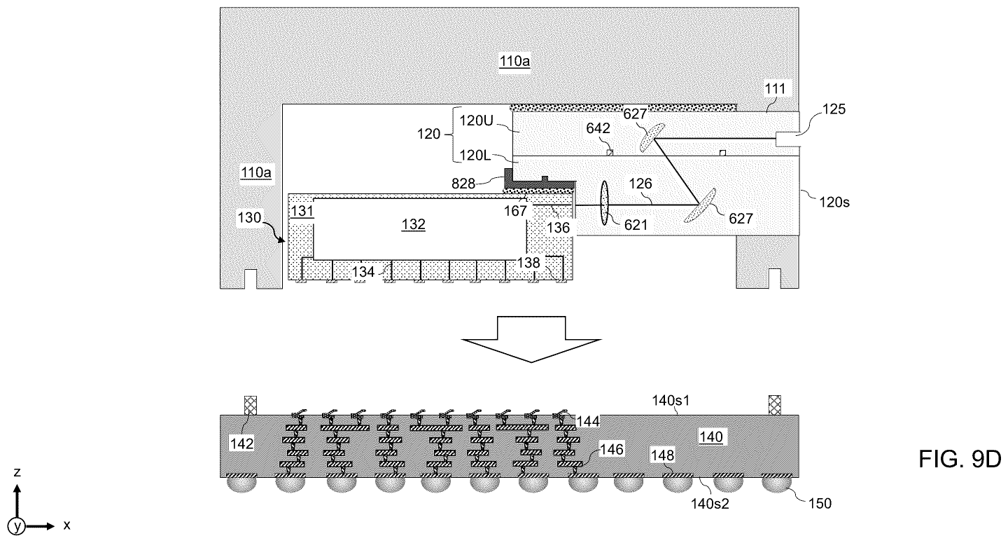

FIGS. 9A-9D illustrate various intermediate structures that may be formed in a method of making the OE module 100 having the third alternative design according to one or more embodiments. It should be noted that various components may be located or positioned in the method using an electromechanical pick-and-place (PnP) machine.

FIG. 9A is a vertical cross-sectional view of an intermediate structure including the general receptacle 828 on the fiber array unit 120 in the third alternative design of the OE module 100 according to one or more embodiments. The general receptacle 828 may be located under the fiber array unit 120 so that the guide pins 822 are substantially aligned with the respective openings in the fiber array unit lower portion 120L. The general receptacle 828 may then be pressed onto the fiber array unit lower portion 120L so that the guide pins 822 on general receptacle 828 are inserted into the respective openings in the fiber array unit lower portion 120L.

FIG. 9B is a vertical cross-sectional view of an intermediate structure including the backplate 110 in the third alternative design of the OE module 100 according to one or more embodiments. The adhesive layer 166 may be applied to the upper surface of the fiber array unit 120. The fiber array unit 120 may then be inserted into the backplate 110. In particular, the fiber array unit 120 may be inserted in the opening 111 in the sidewall portion 110b of the backplate 110. As the fiber array unit 120 is being inserted into the opening 111, the fiber array unit 120 may pressed onto the adhesive layer 166 on the bottom surface 110a-S of the plate portion 110a of the backplate 110. The fiber array unit 120 may then be clamped to the backplate 110 until the adhesive layer 166 is cured.

FIG. 9C is a vertical cross-sectional view of an intermediate structure including the OE die 130 in the first alternative design of the OE module 100 according to one or more embodiments. As illustrated in FIG. 9C, the adhesive layer 167 may be applied to the upper surface of the OE die 130. The OE die 130 may then be pressed into position on the bottom surface of the general receptacle 828. The OE die 130 may then be clamped onto the general receptacle 828 until the adhesive layer 167 is cured.

The OE die 130 may be attached to the general receptacle so as to be substantially coplanar with the fiber array unit 120. In particular, the optical path 136 of the OE die 130 may be made to be substantially aligned with the optical path 126 in the fiber array unit 120. This may be satisfied, for example, by visual inspection to verify the distance between the bottom surface of the OE die 130 and the bottom surface of the fiber array unit 120 is set to the specified distance L3.

FIG. 9D is a vertical cross-sectional view of an intermediate structure including the socket 140 in the third alternative design of the OE module 100 according to one or more embodiments. As illustrated in FIG. 9D, after the adhesive layer 167 has cured, the backplate 110 including the attached OE die 130 may be attached to the socket 140. The backplate 110 may be positioned over the socket 140 so that the guide pins 142 on the upper surface 140s1 of the socket 140 may be substantially aligned with the openings 113 in the sidewall portion 110b of the backplate 110. The backplate 110 may then be pressed firmly onto the socket 140 so that the connector contacts 138 firmly contact the connector pins 144, and the OE die 130 is electrically coupled to the socket 140. The backplate 110 may then be securely attached to the socket 140 using a fastening mechanism (not shown) such as a latch or socket set screw.

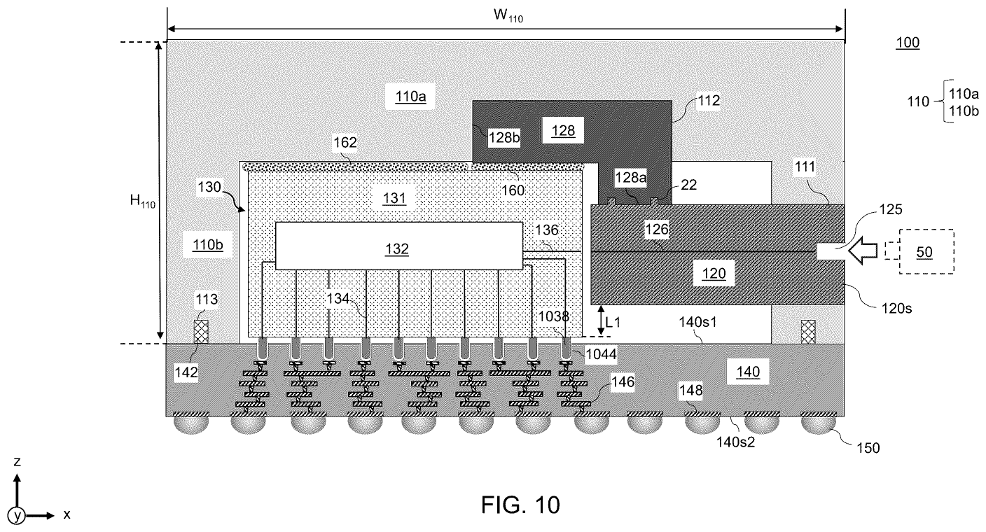

FIG. 10 is a vertical cross-sectional view of an OE module 100 having a fourth alternative design according to one or more embodiments. As illustrated in FIG. 10, the OE module 100 having the fourth alternative design may be substantially the same as the OE module 100 in FIGS. 1A-1C. However, the fourth alternative design may differ from the OE module 100 in FIGS. 1A-1C in that the fourth alternative design may include a different connection mechanism between the optical die 130 and the socket 140.

As illustrated in FIG. 10, instead of the connector contacts 138, the OE die 130 in the fourth alternative design may include a plurality of connector pins 1038 projecting from the bottom surface of the OE die 130. The connector pin 1038 may be formed in a 2×2 array on the bottom surface of the OE die 130.

The connector pins 1038 may be formed of a conductive material such as gold, copper, or other suitable metal material. The connector pins 1038 may include, for example, a probe pin, a microelectro-mechanical system (MEMS) pin, etc. The connector pins 1038 may include a count of less than about 20,000, a pin density of less than about 50 pins/mm² and a pin pitch of less than about 200 μm. The connector pins 1038 may be electrically coupled to the optical engine circuitry 132 by the electrical wiring 134.

Instead of the connector pins 144 as shown in the embodiments illustrated in FIGS. 1A-9D, in the fourth alternative design, the upper surface 140s1 of the socket 140 may include a plurality of connector pin openings 1044. The connector pin openings 1044 may be formed in a 2×2 array in the upper surface 140s1 of the socket 140.

A wall of the connector pin openings 1044 may include a conductive contact surface such as a metal contact surface (e.g., formed of gold, copper or other suitable metal). The connector pins 1038 of the OE die 130 may be inserted into the connector pin openings 1044 to electrically couple the OE die 130 to the socket 140. The connector pins 1038 may be insertable into the connector pin openings 1044 to detachably connect the optical engine die 130 to the socket 140.

The connector pin openings 1044 may be configured to receive the connector pins 1038, respectively. The connector pin openings 1044 may have a number, shape and arrangement corresponding to a number, shape and arrangement of the connector pins 1038. In particular, the connector pin openings 1044 may include a count of less than about 20,000, a density of less than about 50 openings/mm² and an opening pitch of less than about 200 μm.

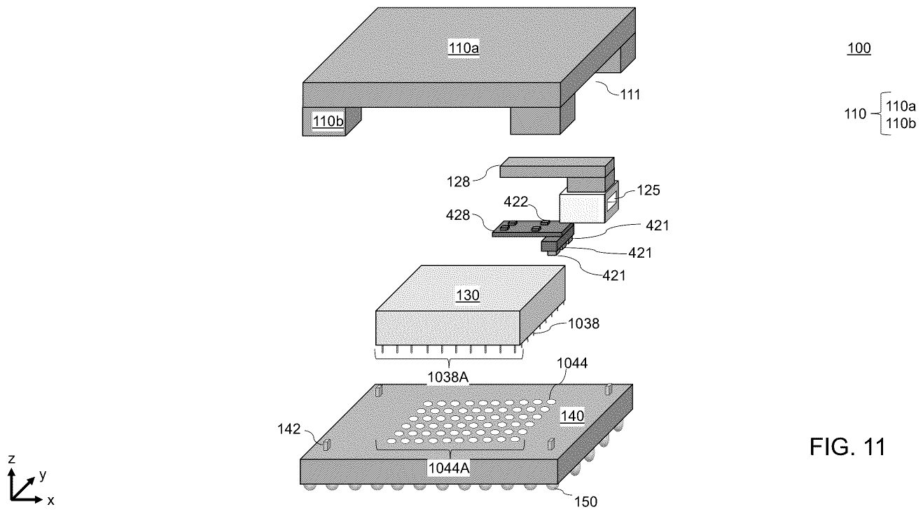

FIG. 11 is an exploded perspective view of an OE module 100 having a fifth alternative design according to one or more embodiments. As illustrated in FIG. 11, the OE module 100 having the fifth alternative design may be substantially the same as the OE module 100 in FIGS. 1A-1C. However, the fifth alternative design may differ from the OE module 100 in FIGS. 1A-1C in several respects.

In particular, as illustrated in the fifth alternative design, the sidewall portion 110b of the backplate 110 may be formed of four sidewall pillars located at the corners of the plate portion 110a of the backplate 110. The opening 111 in the fifth alternative design may extend substantially between the sidewall pillars. Thus, in the fifth alternative design, the backplate 110 an open design compared to the closed design in FIGS. 1A-1C.

In addition, in the fifth alternative design, the microlens receptacle 428 may include a plurality of microlenses 421 (e.g., three microlenses). The microlenses 42 may be substantially aligned in the y-direction. Although not shown in FIG. 11, the fiber array unit 120 may include a plurality of optical channels (e.g., three optical channels) aligned in y-direction at locations corresponding to locations of the plurality of microlenses 421, respectively.

As further illustrated in FIG. 11, the optical die 130 may include a connector pin array 1038A including a plurality of the connector pins 1038 (see FIG. 10). The socket 140 may also include a connector pin opening array 1044A including a plurality of the connector pin openings 1044 (see FIG. 10). Thus, in the fifth alternative design the optical die 130 may be electrically coupled to the socket 140 by inserting the connector pins 1038 of the connector pin array 1038A into the connector pin openings 1044 of the connector pin opening array 1044A.

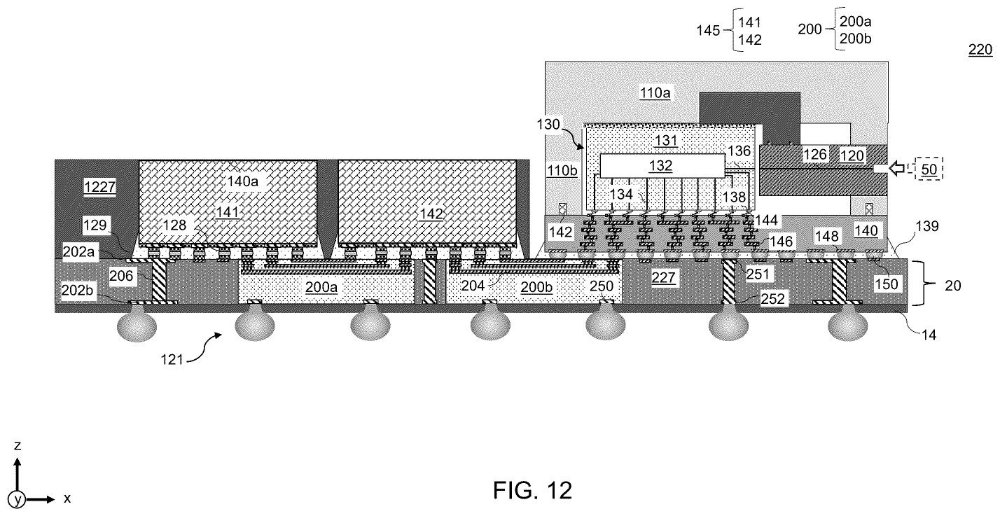

FIG. 12 is a vertical cross-sectional view of a package module 220 according to one or more embodiments. As illustrated in FIG. 12, the package module 220 may include the OE module 100.

In the package module 220, the OE module 100 may be mounted on an interposer 20. One or more semiconductor dies 145 may also be mounted on the interposer 20 adjacent the OE module 100. The interposer 20 may include one or more bridge dies 200 (e.g., connect dies, local silicon interconnect (LSI) dies, etc.). The bridge dies 200 may interconnect the semiconductor dies 145 and the OE module 100. The OE module 100 may thus constitute co-packaged optics (CPO) in the package module 220.

Although the package module 220 is illustrated as including a particular number of semiconductor dies having a particular arrangement, the number of semiconductor dies and the arrangement of the semiconductor dies is not limited to any particular number and arrangement. In particular, the package module 220 may include any number and arrangement of semiconductor dies and any number and arrangement of semiconductor die sets.

The interposer 20 is not necessarily limited to any particular materials or configuration. The interposer 20 may include, for example, organic material (e.g., dielectric polymer), inorganic material (e.g., silicon), glass substrate, etc.

As illustrated in FIG. 12, the interposer 20 may be formed of a molded portion. The interposer 20 may include a lower passivation layer 14. The lower passivation layer 14 may include silicon oxide, silicon nitride, low-k dielectric materials such as carbon-doped oxides, extremely low-k dielectric materials such as porous carbon doped silicon dioxide, a combination thereof or other suitable material.

The interposer 20 may also include a molding material layer 227 (e.g., encapsulation layer) formed on the lower passivation layer 14. In at least one embodiment, the molding material layer 227 may be formed of a curable material that may cure to form a hard, solid structure. The molding material layer 227 may include, for example, epoxy molding compound (EMC). In at least one embodiment, the molding material layer 227 may include a polymeric material and in particular, an epoxy-based polymeric material. Other suitable molding materials may be used.

The interposer 20 of the interposer 20 may also include one or more local silicon interconnect (LSI) dies 200a, 200b. The molding material layer 227 may be formed around the bridge dies 200a, 200b in the x-direction and y-direction. In at least one embodiment, the bridge dies 200a, 200b may be substantially embedded in the molding material layer 227. The bridge dies 200a, 200b may include lower contacts 250 located at a bottom surface of the bridge dies 200a, 200b.

The bridge dies 200a, 200b may include one or more interconnect structures 204 (e.g., metal traces and metal vias) for interconnecting the semiconductor dies 145 in the package module 220. In particular, the bridge die 200a may include one or more interconnect structures 204 for connecting the first semiconductor die 141 to the second semiconductor die 143. The bridge die 200b may include one or more interconnect structures 204 for connecting the second semiconductor die 143 to the OE module 100. The first semiconductor die 141 may be connected to the OE module 100 via the bridge die 200a and the bridge die 200b.

In at least one embodiment, the plurality of interconnect structures 204 in each of the bridge dies 200a, 200b may provide a high routing density die-to-die interconnect through multiple layers of sub-micron metal (e.g., copper) lines. The interconnect structures 204 may allow the bridge dies 200a, 200b to accommodate a plurality of different connection architectures (e.g., SoC to SoC, SoC to chiplet, SoC to HBM, etc.). The interconnect structures 204 may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

The interposer 20 may also integrate additional elements, such as a stand-alone IPDs (not shown). In at least one embodiment, the IPDs may be located in the molding material layer 227 underneath the one or more of the semiconductor dies 145 or the OE module 100 to support signal communication.

The interposer 20 may also include one or more upper redistribution layers (RDL layers) 202a (e.g., metal traces) on a chip-side surface (e.g., upper surface) of the interposer 20 (e.g., on an upper surface of the molding material layer 227). The interposer 20 may also include one or more lower RDL layers 202b and on a board-side surface (e.g., lower surface) of the interposer 20 (e.g., on a lower surface of the molding material layer 227).

The interposer 20 may include one or more interposer upper bonding pads 251 on the upper surface of the molding material layer 227, and one or more interposer lower bonding pads 252 on the lower surface of the molding material layer 227. The interposer 20 may also include one or more through interposer vias (TIVs) 206 in the molding material layer 227. The TIVs 206 may be connected to the interposer upper bonding pads 251 and the interposer lower bonding pads 252.

The upper RDL layers 202a and lower RDL layers 202b may include a wide pitch and may be connected to each other by the TIVs 206 for efficient signal and power delivery. The upper RDL layers 202a, lower RDL layers 202b, TIVs 206, interposer upper bonding pads 251 and interposer lower bonding pads 252 may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure. With such a configuration, the interposer 20 may provide low loss of high frequency signal in high-speed transmission.

The package module 220 may include a plurality of C4 bumps 121 on the board-side surface of the interposer 20. The C4 bumps 121 may be formed in the openings in the lower passivation layer 14 and may contact the interposer lower bonding pads 252 through openings in the lower passivation layer 14. The C4 bumps 121 may contact the interposer lower bonding pads 252 through the openings in the lower passivation layer 14. The C4 bumps 121 may also contact the lower contacts 250 in the bridge dies 200a, 200b through the C4 bumps 121.

In at least one embodiment, the C4 bumps 121 may be formed by forming one or more underbump metallization (UBM) layers (not shown) on the interposer lower bonding pads 252, forming contact pads on the UBM layers, and forming solder bumps on the contact pads.

The semiconductor dies 145 may be mounted on the interposer 20 over one or more of the bride dies 200a, 200b. Generally, a thickness in the z-direction of each of the semiconductor dies 145 may be substantially the same. Thus, the upper surfaces of each of the first semiconductor die 141 and second semiconductor die 143 may be substantially coplanar (e.g., formed in the same x-y plane), and referred to collectively as the semiconductor die upper surface 140a (upper surface).

The semiconductor dies 145 may be mounted on the interposer 20, for example, by microbumps 118. The microbumps 118 may each include a copper post and a solder bump on the copper post. The microbumps 118 may be bonded (e.g., by the solder bump) to metal contacts on the chip-side surface of the interposer 20. In at least one embodiment, the microbumps 118 may be bonded to the interconnect structures 204 in the bridge dies 200a, 200b. In at least one embodiment, the microbumps 118 may be bonded to TIVs 206 in the interposer 20. In at least one embodiment, the microbumps 118 may be bonded to the upper RDL layers 202a on the chip-side surface of the interposer 20. The semiconductor dies 145 may, therefore, be connected to the C4 bumps 121 through the microbumps 118, the upper RDL layers 202a, the TIVs 206 and the lower RDL layers 202b.

A package module underfill layer 129 may be formed (e.g., individually or connectively) under and around each of the semiconductor dies 145. The package module underfill layer 129 may also be formed around the microbumps 118. The package module underfill layer 129 may thereby fix each of the semiconductor dies 145 to the interposer 20. The package module underfill layer 129 may be formed of an epoxy-based polymeric material.

Each of the semiconductor dies 145 may include, for example, a singular semiconductor die, a system on chip (SOC) die, or a system on integrated chips (SoIC) die, and may be implemented by chip on wafer on substrate (CoWoS) technology or integrated fan-out on substrate (INFO-oS) technology. In particular, each of the semiconductor dies 145 may include, for example, a semiconductor chip or chiplet for a high performance computing (HPC) application, an artificial intelligence (AI) application, and a 5G cellular network application, a logic die (e.g., mobile application processor, microcontroller, etc.), or a memory die (e.g., high-bandwidth memory (HBM) die, hybrid memory cube (HMC), dynamic random access memory (DRAM) die, a Wide I/O die, a M-RAM die, a R-RAM die, an inverted AND (NAND) die, static random access memory (SRAM), etc.), a central processing unit (CPU) chip, graphics processing unit (GPU) chip, field-programmable gate array (FPGA) chip, networking chip, application-specific integrated circuit (ASIC) chip, artificial intelligence/deep neural network (AI/DNN) accelerator chip, etc., a co-processor, accelerator, an on-chip memory buffer, a high data rate transceiver die, a I/O interface die, an integrated passive device (IPD) die, a power management die (e.g., power management integrated circuit (PMIC) die), a radio frequency (RF) die, a sensor die, a micro-electro-mechanical-system (MEMS) die, a signal processing die (e.g., digital signal processing (DSP) die), a front-end die (e.g., analog front-end (AFE) die), a monolithic 3D heterogeneous chiplet stacking die, etc. Other dies are within the contemplated scope of this disclosure.

In at least one embodiment, the first semiconductor die 141 and the second semiconductor die 143 may include an ASIC die. In particular, the first semiconductor die 141 and the second semiconductor die 143 (e.g., ASIC dies) may be configured to include applications specific to the OE module 100.

The package module 220 may also include an upper molding material layer 1227 formed around the semiconductor dies 145. The upper molding material layer 1227 may also be formed on and around the package module underfill layer 129. The upper molding material layer 1227 may have an outer sidewall that is substantially aligned with the outer sidewall of the interposer 20.

In at least one embodiment, the upper molding material layer 1227 may be formed on sidewalls (inner sidewall and outer sidewall) of each of the semiconductor dies 145. The upper molding material layer 1227 may be formed between and bonded to the sidewalls of each of the semiconductor dies 145. The upper molding material layer 1227 may also be bonded to the chip-side surface of the interposer 20 and the package module underfill layer 129.

In at least one embodiment, the upper molding material layer 1227 may be formed of a curable material that may cure to form a hard, solid structure. The upper molding material layer 1227 may include, for example, epoxy molding compound (EMC). In at least one embodiment, the upper molding material layer 1227 may include a material that is substantially similar to the package module underfill layer 129, and or substantially similar to the molding material layer 227 in the interposer 20. In at least one embodiment, the upper molding material layer 1227 may include a polymeric material and in particular, an epoxy-based polymeric material. Other suitable molding materials may be within the contemplated scope of disclosure.

As further illustrated in FIG. 12, the OE module 100 may be mounted on the interposer 20 through the solder balls 150 of the ball-grid array (BGA) on the bottom of the socket 140. At least a portion of the solder balls 150 may be connected to the interconnect structures 204 in the bridge die 200b. The OE module 100 may be communicatively coupled to the second semiconductor die 143 via the interconnect structures 204 in the bridge die 200b. At least a portion of the solder balls 150 may be connected to the interposer upper bonding pads 251. At least a portion of the solder balls 150 may be connected to the upper RDL layers 202a.

A package module underfill layer 139 may be formed under and around the socket 140. The package module underfill layer 139 may also be formed around the solder balls 150. The package module underfill layer 139 may thereby fix the OE module 100 to the interposer 20. The package module underfill layer 139 may be formed of an epoxy-based polymeric material or other suitable material.

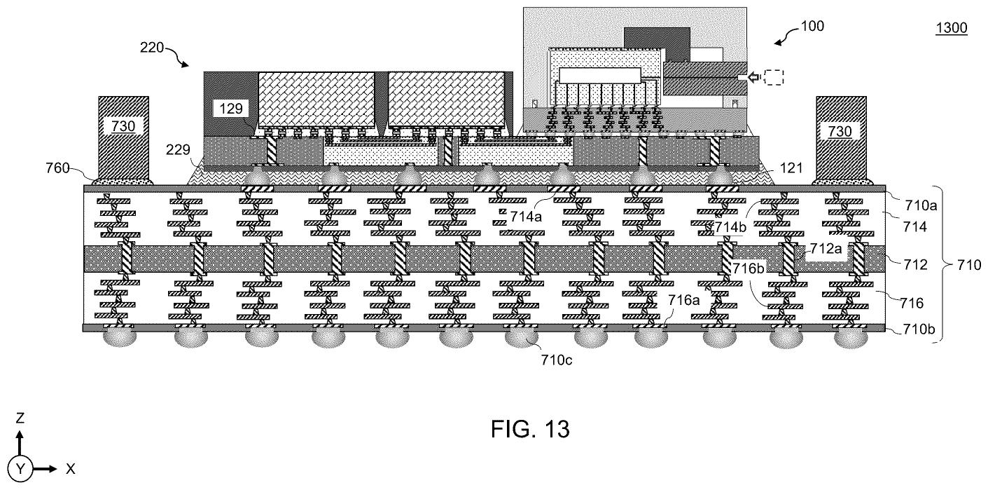

FIG. 13 is a vertical cross-sectional view of package structure 1300 including the package module 220 according to one or more embodiments.

The package structure 1300 may include a package substrate 710. The package substrate 710 may constitute a substrate of a multi-chip module (MCM). The package substrate 710 may include a cored or coreless substrate. In at least one embodiment, for example, the package substrate 710 may include a core 712, a package substrate upper dielectric layer 714 formed on the core 712 (e.g., a first side or chip-side of the package substrate 710), and a package substrate lower dielectric layer 716 formed on the core 712 (e.g., a second side or board-side of the package substrate 710). In particular, the package substrate 710 may include a build-up film substrate such as an Ajinomoto build-up film (ABF) substrate. That is, in at least one embodiment, each of the package substrate upper dielectric layer 714 and the package substrate lower dielectric layer 716 may be described as an ABF layer.

The core 712 may help to provide rigidity to the package substrate 710. The core 712 may include, for example, an epoxy resin such as a bismaleimide triazine epoxy (BT epoxy) and/or a woven glass laminate. The core 712 may alternatively or in addition include an organic material such as a polymer material. In particular, the core 712 may include a dielectric polymer material such as polyimide (PI), benzocyclo-butene (BCB), or polybenzobisoxazole (PBO). Other suitable dielectric materials are within the contemplated scope of disclosure.

The core 712 may include one or more through vias 712a. The through vias 712a may extend from a lower surface of the core 712 to an upper surface of the core 712. The through vias 712a may allow an electrical connection between the package substrate upper dielectric layer 714 and the package substrate lower dielectric layer 716. The through vias 712a may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

The package substrate upper dielectric layer 714 may be formed on an upper surface of the core 712. The package substrate upper dielectric layer 714 may include a plurality of layers and, in particular, may include a build-up film (e.g., ABF). The package substrate upper dielectric layer 714 may also include an organic material such as a polymer material. In particular, the package substrate upper dielectric layer 714 may include a dielectric polymer material such as polyimide (PI), benzocyclobutene (BCB), or polybenzobisoxazole (PBO). Other suitable dielectric materials are within the contemplated scope of disclosure.

The package substrate upper dielectric layer 714 may include one or more package substrate upper bonding pads 714a on a chip-side surface of the package substrate upper dielectric layer 714. In particular, the package substrate upper bonding pads 714a may be exposed on the chip-side surface of the package substrate upper dielectric layer 714. The package substrate upper dielectric layer 714 may also include one or more metal interconnect structures 714b. The metal interconnect structures 714b may be connected to the package substrate upper bonding pads 714a and the through vias 712a in the core 712. The metal interconnect structures 714b may include metal layers (e.g., copper traces) and metal vias connecting the metal layers. The package substrate upper bonding pads 714a and the metal interconnect structures 714b may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

A package substrate upper passivation layer 710a may be formed on the chip-side surface of the package substrate upper dielectric layer 714. The package substrate upper passivation layer 710a may partially cover the package substrate upper bonding pads 714a. The upper passivation layer 714a may include silicon oxide, silicon nitride, low-k dielectric materials such as carbon-doped oxides, extremely low-k dielectric materials such as porous carbon doped silicon dioxide, a combination thereof or other suitable material.

The package substrate lower dielectric layer 716 may be formed on an lower surface of the core 712. The package substrate lower dielectric layer 716 may also include a plurality of layers and, in particular, may include a build-up film (e.g., ABF). The package substrate lower dielectric layer 716 may also include an organic material such as a polymer material. In particular, the package substrate lower dielectric layer 716 may include a dielectric polymer material such as polyimide (PI), benzocyclobutene (BCB), or polybenzobisoxazole (PBO). Other suitable dielectric materials are within the contemplated scope of disclosure.

The package substrate lower dielectric layer 716 may include one or more package substrate lower bonding pads 716a on a board-side surface of the package substrate lower dielectric layer 716. In particular, the package substrate lower bonding pads 716a may be exposed on the board-side surface of the package substrate lower dielectric layer 716. The package substrate lower dielectric layer 716 may also include one or more metal interconnect structures 716b. The metal interconnect structures 716b may be connected to the package substrate lower bonding pads 716a and the through vias 712a in the core 712. The metal interconnect structures 716b may include metal layers (e.g., copper traces) and metal vias connecting the metal layers. The package substrate lower bonding pads 716a and the metal interconnect structures 716b may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

A package substrate lower passivation layer 710b may be formed on the board-side surface of the package substrate lower dielectric layer 716. The package substrate lower passivation layer 710b may partially cover the package substrate lower bonding pads 716a. The package substrate lower passivation layer 710b may include silicon oxide, silicon nitride, low-k dielectric materials such as carbon-doped oxides, extremely low-k dielectric materials such as porous carbon doped silicon dioxide, a combination thereof or other suitable material.

A ball-grid array (BGA) including a plurality of solder balls 710c may be formed on the board-side surface of the package substrate lower dielectric layer 716. The solder balls 710c may allow the package structure 1300 to be securely mounted on a substrate such as a printed circuit board (PCB) and electrically coupled to the PCB substrate. The solder balls 710c may contact the package substrate lower bonding pads 716a, respectively. The solder balls 710c may therefore be electrically connected to the package substrate upper bonding pads 714a by way of metal interconnect structures 716b, the through vias 712a and the metal interconnect structures 714b.

The package module 220 may be connected to the package substrate 710 by the C4 bumps 121 on the board-side surface of the interposer 20. In particular, the C4 bumps 121 may be bonded (e.g., using solder reflow, compression bonding, thermocompression bonding, etc.) to the package substrate upper bonding pads 714a of the package substrate 710.

The package module 220 may be bonded to the blackplate 110 by a package underfill layer 229. The package underfill layer 229 may be substantially similar to the package module underfill layer 129 in the package module 220. The package underfill layer 229 may be formed under the interposer 20 and around the C4 bumps 121. The package underfill layer 229 may also be formed on the sidewall of the interposer 20.

The package structure 1300 may also include a stiffener ring 730 on the package substrate 710. The stiffener ring 730 may be formed, for example, of a metal material such as aluminum, copper, stainless steel, etc. The stiffener ring 730 may be attached to the package structure 1300 by the adhesive layer 760. In particular, the stiffener ring 730 may be attached through the adhesive layer 760 to the package substrate upper passivation layer 710a. The adhesive layer 760 may include an epoxy adhesive, silicon adhesive, etc. Other adhesives are within the contemplated scope of disclosure.

The stiffener ring 730 may be continuously formed around an entire periphery of the package module 220. The stiffener ring 730 may have a shape that is substantially similar to an outer shape of the package module 220. In particular, the stiffener ring 730 may have a substantially rectangular outer shape and a substantially rectangular inner shape. Other suitable shapes of the stiffener ring 730 may be used.

A width of the stiffener ring 730 may be substantially uniform around the entire periphery of the package module 220. In at least one embodiment, the width of the stiffener ring 730 may be greater than the distance between the inner wall of the stiffener ring and the package module 220.

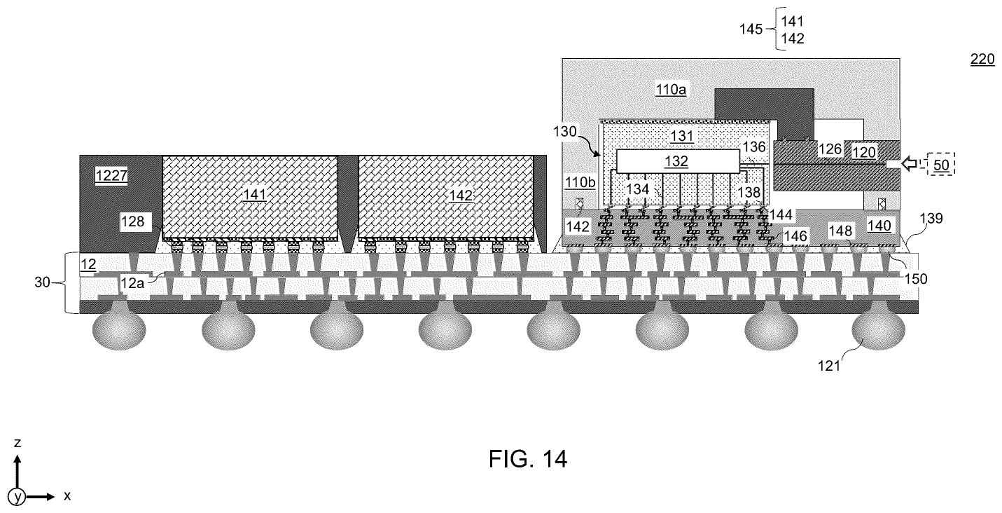

FIG. 14 is a vertical cross-sectional view of a package module 220 having a first alternative design according to one or more embodiments.

As illustrated in FIG. 14, the package module 220 having the first alternative may be substantially similar to the package module 220 in FIG. 12. However, in the package module 220 having the first alternative design, the OE module 100 may be mounted on an RDL structure 30. The semiconductor dies 145 may also be mounted on the RDL structure 30 adjacent the OE module 100. The RDL structure 30 may optionally include one or more bridge dies (not shown) similar to the bridge dies 200 in FIG. 12. The RDL structure 30 may interconnect the semiconductor dies 145 and the OE module 100. The OE module 100 may thus constitute co-packaged optics (CPO) in the package module 220 having the first alterative design.

As illustrated in FIG. 14, the RDL structure 30 may include a plurality of polymer layers 12 and a plurality of redistribution layers 12a stacked alternately. The number of the polymer layers 12 and/or the number of redistribution layers 12a in the RDL structure 30 are not limited by the disclosure. The RDL structure 30 may alternatively or additionally include an RDL molding layer encapsulating the redistribution layers 12a.

In at least one embodiment, the polymer layers 12 may include, for example, polyimide (PI), epoxy resin, acrylic resin, phenol resin, benzocyclobutene (BCB), polybenzoxazole (PBO), or any other suitable polymer-based dielectric material. In some embodiments, the redistribution layers 12a may include conductive materials. The conductive materials may include metal such as copper, aluminum, nickel, titanium, a combination thereof. Other suitable conductive materials may be within the contemplated scope of disclosure.

In at least one embodiment, the redistribution layers 12a may include a plurality of metal traces (lines) and a plurality of metal vias connecting the plurality traces to each other. The traces may be respectively located on the polymer layers 12, and may extend in the x-direction (first horizontal direction) and y-direction (second horizontal direction) on an upper surface of the polymer layers 12.

An upper passivation layer (not shown) may optionally be formed on the chip-side surface of the RDL structure 30. The upper passivation layer may include silicon oxide, silicon nitride, low-k dielectric materials such as carbon-doped oxides, extremely low-k dielectric materials such as porous carbon doped silicon dioxide, a combination thereof or other suitable material. One or more upper bonding pads (not shown) may also be formed in the upper passivation layer. The upper bonding pads may be connected to the redistribution layers 12a. The upper bonding pads may include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

A lower passivation layer 14 may be formed on the board-side surface of the RDL structure 30. The lower passivation layer 14 may also include silicon oxide, silicon nitride, low-k dielectric materials such as carbon-doped oxides, extremely low-k dielectric materials such as porous carbon doped silicon dioxide, a combination thereof or other suitable material.

One or more lower bonding pads (not shown) may be located on the board-side surface of RDL structure 30. The lower bonding pads may be bonded to and electrically connected to the redistribution layers 12a. The lower bonding pads may be located in the lower passivation layer 14. The lower bonding pads may also include, for example, one or more layers and may include metals, metal alloys, and/or other metal-containing compounds (e.g., Cu, Al, Mo, Co, Ru, W, TiN, TaN, WN, etc.). Other suitable metal materials are within the contemplated scope of disclosure.

As further illustrated in FIG. 14, the plurality of C4 bumps 121 may connected to the redistribution layers 12a on the board-side surface of the RDL structure 30. In at least one embodiment, the C4 bumps 121 may include underbump metallurgy (UBM) layers on the redistribution layers 12a. The C4 bumps 121 may further include a contact pad (e.g., copper/nickel contact pad) on the UBM layers and a solder bump (e.g., SnAg solder bump) on the contact pad. The C4 bumps 121 may allow the package module 220 to be connected to a substrate such as a package substrate.

The semiconductor dies 145 (e.g., ASIC dies) may be connected to the redistribution layers 12a on the chip-side surface of the RDL structure 30. In particular, the semiconductor dies 145 may be connected to the redistribution layers 12a by the microbumps 118. The OE module 100 may be connected to the redistribution layers 12a by the solder balls 150. The semiconductor dies 145 may be communicatively coupled to the OE module 100 through the RDL structure 30.

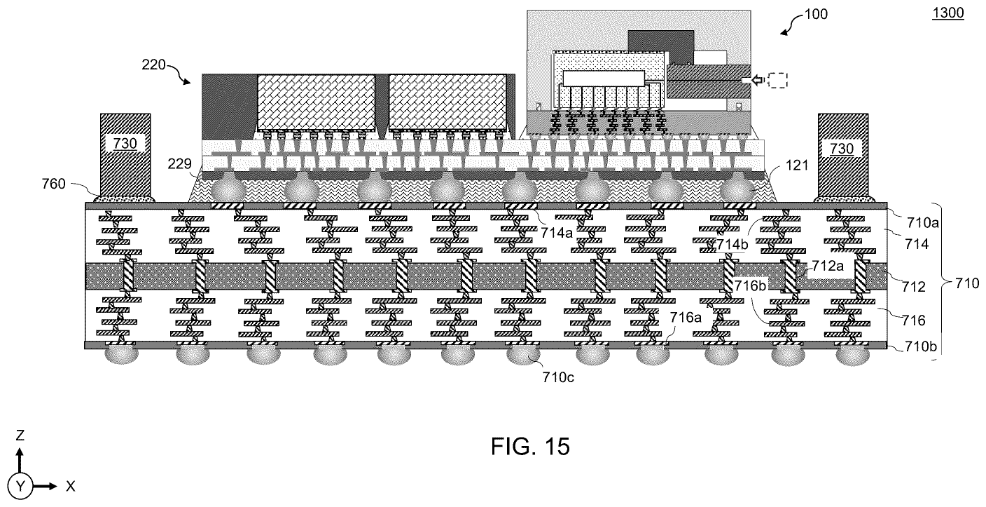

FIG. 15 is a vertical cross-sectional view of the package structure 1300 having a first alternative design according to one or more embodiments. The package structure 1300 having the first alternative design may be substantially similar to the package structure 1300 in FIG. 13. However, the package structure 1300 having the first alternative design may include the package module 220 having the first alternative design in FIG. 14. The description of the package structure 1300 with respect to FIG. 13 above may be equally applicable to the package structure 1300 having the first alternative design in FIG. 15.

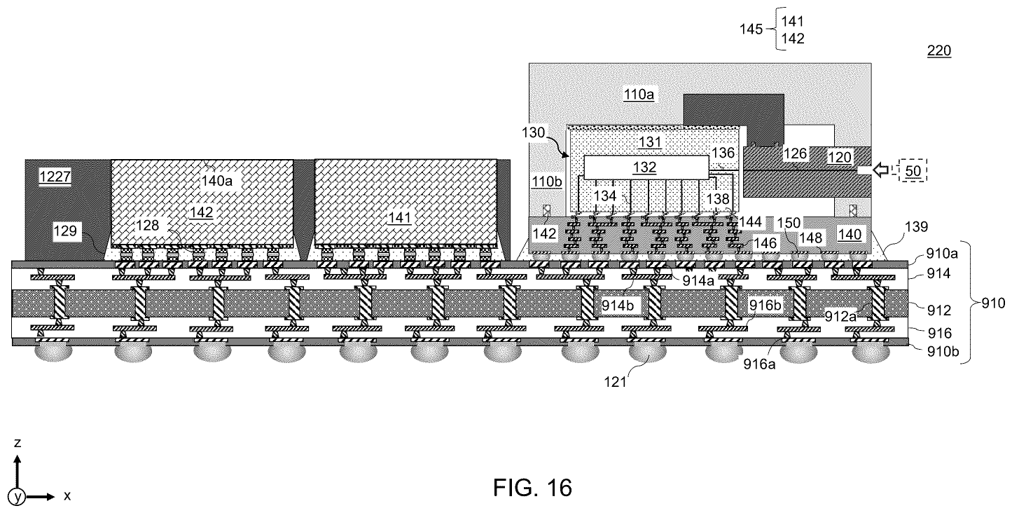

FIG. 16 is a vertical cross-sectional view of a package module 220 having a second alternative design according to one or more embodiments.

As illustrated in FIG. 16, the package module 220 having the second alternative may be substantially similar to the package module 220 in FIG. 12. However, in the package module 220 having the second alternative design, the OE module 100 may be mounted on a substrate 910. The semiconductor dies 145 may also be mounted on the substrate 910 adjacent the OE module 100. The substrate 910 may optionally include one or more bridge dies (not shown) similar to the bridge dies 200 in FIG. 12. The substrate 910 may interconnect the semiconductor dies 145 and the OE module 100. The OE module 100 may thus constitute co-packaged optics (CPO) in the package module 220 having the second alterative design.

The substrate 910 may include a cored or coreless substrate. The substrate 910 may have a structure substantially similar to the package substrate 710 in FIG. 13 and FIG. 15.

In particular, the substrate 910 may include a substrate upper passivation layer 910a substantially similar to the package substrate upper passivation layer 710a, a substrate upper dielectric layer 914 substantially similar to the package substrate upper dielectric layer 714, a core 912 substantially similar to the core 712, substrate lower dielectric layer 916 substantially similar to the package substrate lower dielectric layer 716, and a substrate lower passivation layer 910b substantially similar to the package substrate lower passivation layer 710b. The substrate 910 may also include substrate upper bonding pads 914a substantially similar to the package substrate upper bonding pads 714a, metal interconnect structures 914b substantially similar to metal interconnect structures 716b, through vias 912a substantially similar to the through vias 712a, substrate lower bonding pads 916a substantially similar to the package substrate lower bonding pads 716a, and metal interconnect structures 916b substantially similar to metal interconnect structures 716b. The C4 bumps 121 may be connected to the substrate lower bonding pads 916a in the second alternative design of the package module 220.

As illustrated in FIG. 16, the semiconductor dies 145 (e.g., ASIC dies) may be connected to the substrate upper bonding pads 914a on the chip-side surface of the substrate 910. In particular, the semiconductor dies 145 may be connected to the substrate upper bonding pads 914a by the microbumps 118. The OE module 100 may be connected to the substrate upper bonding pads 914a by the solder balls 150. The semiconductor dies 145 may be communicatively coupled to the OE module 100 through the substrate 910.

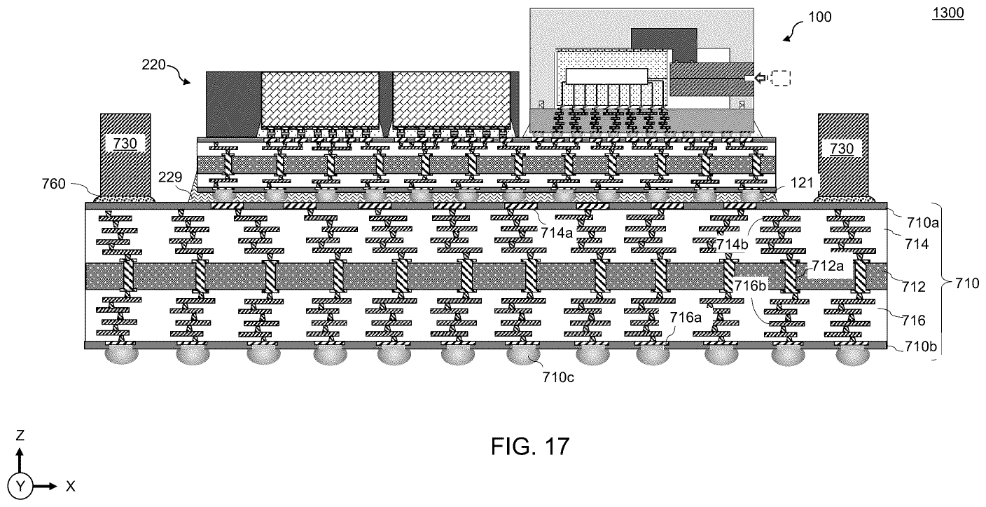

FIG. 17 is a vertical cross-sectional view of the package structure 1300 having a second alternative design according to one or more embodiments. The package structure 1300 having the second alternative design may be substantially similar to the package structure 1300 in FIG. 13. However, the package structure 1300 having the second alternative design may include the package module 220 having the second alternative design in FIG. 16. The description of the package structure 1300 with respect to FIG. 13 above may be equally applicable to the package structure 1300 having the second alternative design in FIG. 17.

The various embodiments may include a pluggable (e.g., detachable) OE module 100 (e.g., pluggable OE module assembly) including the socket 140 for optical input/output (I/O). The socket 140 may allow the OE module 100 to be detachably connected to a substrate (e.g., MCM substrate). The OE module 100 may also include a OE die 130 and fiber array unit 120 on the backplate 110. The OE die 130 and fiber array unit 120 may also be pluggable (e.g., detachably mounted on the backplate 110). A pluggable multi-fiber push-on/pull-off (MPO) 50 may also be detachably connected to the fiber array unit 120. The backplate 110 may provide a rigid structure that enhances the physical module during insertion/removal of the OE die 130, fiber array unit 120 or MPO 50 in the pluggable OE module 100.

The socket 140 and backplate 110 may allow the OE die 130 to be combined with the fiber array unit 120 to achieve a pluggable OE module solution. Such a configuration may allow the OE die 130 to be conveniently exchanged without impacting a function of other dies (e.g., ASIC die) on the substrate (e.g., MCM substrate). The pluggable OE module 100 may allow for more flexibility and convenience in network configuration and maintenance.

In some instances, the OE die 130 may become damaged in an existing system and such damage may affect the other dies on the MCM substrate. The OE die 130 may be connected to other dies (e.g., ASIC die) through a bridge die (e.g., connect die), and the cost of the other dies may be much greater than OE die 130. Therefore, manufacturing cost may be reduced by using the pluggable (e.g., detachable) OE die 130. The manufacture stability of the OE die 130 may be lower than that of the ASIC dies. Therefore, the detachable design may allow a bad OE die 130 to be removed and a new OE die 130 to be attached in its place. In particular, the fiber array unit 120 may include a pluggable (e.g., detachable) fiber array unit 120 to allow for convenient replacement of a damaged OE die 130. This design may help alleviate concern that a damaged optical engine (OE) die may damage other dies (e.g., application specific integrated circuit (ASIC) dies) on a multi-chip module (MCM) substrate.

Referring to FIGS. 1A-17, an optical engine module 100, may include a backplate 110, a fiber array unit 120 attached to the backplate 110, an optical engine die 130 attached to the backplate 110 adjacent the fiber array unit 120, and a socket 140 attached to the backplate 110 and connected to the optical engine die 130.

In one embodiment, the optical engine die 130 may include a plurality of connector contacts 138, the socket 140 may include a plurality of connector pins 144 configured to contact the plurality of connector contacts 138 to detachably connect the optical engine die 130 to the socket 140. In one embodiment, the plurality of connector pins 144 may include at least one of a probe pin or a microelectromechanical system (MEMS) pin. In one embodiment, the plurality of connector pins 144 may include a count of less than about 20,000, a pin density of less than about 50 pins 144/mm² and a pin pitch of less than about 200 μm. In one embodiment, the socket 140 may include a plurality of solder balls 150 in a ball-grid array on a lower surface of the socket 140 opposite the plurality of connector pins 144, and an interconnect structure 146 configured to electrically couple the plurality of connector pins 144 to the ball-grid array. In one embodiment, the fiber array unit 120 may include a fiber connection port 125 configured to detachably receive a multi-fiber push-on/pull-off (MPO) unit 50. In one embodiment, the fiber connection port 125 may be substantially aligned with an optical path 126 in the fiber array unit 120 and an optical path 136 in the optical engine die 130. In one embodiment, the fiber array unit 120 may include a fiber array unit upper portion 120U including the fiber connection port 125 and a first optical mirror 627U configured to direct an optical signal along an optical path 126 in the fiber array unit upper portion 120U, and a fiber array unit lower portion 120L detachably connected to the fiber array unit upper portion 120U and including a second optical mirror 627L configured to direct an optical signal from the fiber array unit upper portion 120U into the optical engine die 130 and direct an optical signal from the optical engine die 130 into the fiber array unit upper portion 120U. In one embodiment, the optical engine module 100 may further include a fiber array unit holder 128 for holding the fiber array unit 120 on the backplate 110. In one embodiment, the optical engine module 100 may further include a microlens receptacle 428 attached to the fiber array unit holder 128 such that a microlens 421 of the microlens receptacle 428 may be between the optical die and an optical path 126 of the fiber array unit 120. In one embodiment, the optical engine die 130 includes optical engine circuitry 132 configured to receive optical signals from the fiber array unit 120, convert the optical signals into electrical signals, and transmit the electrical signals to the socket 140, and receive electrical signals from the socket 140, convert the electrical signals received from the socket 140 into optical signals, and transmit the optical signals from the optical engine circuitry 132 to the fiber array unit 120.

Referring again to FIGS. 1A-17, a method of forming an optical engine module 100 may include attaching a fiber array unit 120 to a backplate 110, attaching an optical engine die 130 to the backplate 110 adjacent the fiber array unit 120, and attaching the backplate 110 to a socket 140 such that the fiber array unit 120 and the optical engine die 130 may be between the backplate 110 and the socket 140.

In one embodiment, the method may further include attaching a fiber array unit holder 128 to the fiber array unit 120, wherein the attaching of the fiber array unit 120 to the backplate 110 may include attaching the fiber array unit holder 128 to the backplate 110. In one embodiment, the fiber array unit 120 may include a guide pin 22 and the attaching of the fiber array unit holder 128 to the fiber array unit 120 may include inserting the guide pin 22 into an opening in the fiber array unit holder 128. In one embodiment, the method may further include detachably attaching the optical engine die 130 to the socket 140. In one embodiment, the optical engine die 130 may include a plurality of connector contacts 138, and the socket 140 may include a plurality of connector pins 144 configured to contact the plurality of connector contacts 138, and the detachably attaching the optical engine die 130 to the socket 140 may include contacting the plurality of connector pins 144 to the plurality of connector contacts 138, respectively. In one embodiment, the socket 140 may include a plurality of guide pins 144 and the attaching of the backplate 110 to the socket 140 may include inserting the plurality of guide pins 144 into a plurality of openings in the backplate 110.

Referring again to FIGS. 1A-17, a package module 220, may include a mounting structure 20, 30, 910, an optical engine module 100 on the mounting structure 20, 30, 910, the optical engine module 100 may include a backplate 110, a fiber array unit 120 attached to the backplate 110, an optical engine die 130 attached to the backplate 110 adjacent the fiber array unit 120, and a socket 140 attached to the backplate 110 and connected to the optical engine die 130, and a semiconductor die 145 mounted on the mounting structure 20, 30, 910 adjacent the optical engine module 100 and electrically coupled to the optical engine module 100 through the mounting structure 20, 30, 910.

In one embodiment, the mounting structure 20, 30, 910 may include one of a substrate 910, an interposer 20 or a redistribution layer (RDL) structure 30. In one embodiment, the semiconductor die 145 may include an application specific integrated circuit (ASIC) die 145, the mounting structure 20, 30, 910 may include a bridge die 200 and the ASIC die 145 may be electrically coupled to the optical engine module 100 through the bridge die 200.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical engine module, comprising:
a backplate;
a fiber array unit attached to the backplate;
an optical engine die attached to the backplate adjacent the fiber array unit; and
a socket attached to the backplate and connected to the optical engine die.

2. The optical engine module of claim 1, wherein the optical engine die comprises a plurality of connector contacts, the socket comprises a plurality of connector pins configured to contact the plurality of connector contacts to detachably connect the optical engine die to the socket.

3. The optical engine module of claim 2, wherein the plurality of connector pins comprises at least one of a probe pin or a microelectromechanical system (MEMS) pin.

4. The optical engine module of claim 2, wherein the plurality of connector pins comprises a count of less than about 20,000, a pin density of less than about 50 pins/mm² and a pin pitch of less than about 200 μm.

5. The optical engine module of claim 2, wherein the socket comprises:
a plurality of solder balls in a ball-grid array on a lower surface of the socket opposite the plurality of connector pins; and
an interconnect structure configured to electrically couple the plurality of connector pins to the ball-grid array.

6. The optical engine module of claim 1, wherein the fiber array unit comprises a fiber connection port configured to detachably receive a multi-fiber push-on/pull-off (MPO) unit.

7. The optical engine module of claim 6, wherein the fiber connection port is substantially aligned with an optical path in the fiber array unit and an optical path in the optical engine die.

8. The optical engine module of claim 6, wherein the fiber array unit comprises:
a fiber array unit upper portion including the fiber connection port and a first optical mirror configured to direct an optical signal along an optical path in the fiber array unit upper portion; and
a fiber array unit lower portion detachably connected to the fiber array unit upper portion and including a second optical mirror configured to direct an optical signal from the fiber array unit upper portion into the optical engine die and direct an optical signal from the optical engine die into the fiber array unit upper portion.

9. The optical engine module of claim 1, further comprising:
a fiber array unit holder for holding the fiber array unit on the backplate.

10. The optical engine module of claim 9, further comprising:
a microlens receptacle attached to the fiber array unit holder such that a microlens of the microlens receptacle is between the optical die and an optical path of the fiber array unit.

11. The optical engine module of claim 1, wherein the optical engine die includes optical engine circuitry configured to:
receive optical signals from the fiber array unit, convert the optical signals into electrical signals, and transmit the electrical signals to the socket; and
receive electrical signals from the socket, convert the electrical signals received from the socket into optical signals, and transmit the optical signals from the optical engine circuitry to the fiber array unit.

12. A method of forming an optical engine module, the method comprising:
attaching a fiber array unit to a backplate;
attaching an optical engine die to the backplate adjacent the fiber array unit; and
attaching the backplate to a socket such that the fiber array unit and the optical engine die are between the backplate and the socket.

13. The method of claim 12, further comprising:
attaching a fiber array unit holder to the fiber array unit, wherein the attaching of the fiber array unit to the backplate comprises attaching the fiber array unit holder to the backplate.

14. The method of claim 13, wherein the fiber array unit comprises a guide pin and the attaching of the fiber array unit holder to the fiber array unit comprises inserting the guide pin into an opening in the fiber array unit holder.

15. The method of claim 12, further comprising:
detachably attaching the optical engine die to the socket.

16. The method of claim 15, wherein the optical engine die comprises a plurality of connector contacts, and the socket comprises a plurality of connector pins configured to contact the plurality of connector contacts, and the detachably attaching the optical engine die to the socket comprises contacting the plurality of connector pins to the plurality of connector contacts, respectively.

17. The method of claim 12, wherein the socket comprises a plurality of guide pins and the attaching of the backplate to the socket comprises inserting the plurality of guide pins into a plurality of openings in the backplate.

18. A package module, comprising:
a mounting structure;
an optical engine module on the mounting structure, the optical engine module comprising:
a backplate;
a fiber array unit attached to the backplate;
an optical engine die attached to the backplate adjacent the fiber array unit; and
a socket attached to the backplate and connected to the optical engine die; and
a semiconductor die mounted on the mounting structure adjacent the optical engine module and electrically coupled to the optical engine module through the mounting structure.

19. The package module of claim 18, wherein the mounting structure comprises one of a substrate, an interposer or a redistribution layer (RDL) structure.

20. The package module of claim 18, wherein the semiconductor die comprises an application specific integrated circuit (ASIC) die, the mounting structure comprises a bridge die and the ASIC die is electrically coupled to the optical engine module through the bridge die.
